(19) United States
(12) Patent Application Publication
(10) Pub. No.: US 2024/0080363 A1
(43) Pub. Date: Mar. 7, 2024

(54) IOT System

(71) Applicants: Tiejun Wang, Alexandria, VA (US); Tiehong Wang, Alexandria, VA (US)

(72) Inventors: Tiejun Wang, Alexandria, VA (US); Tiehong Wang, Alexandria, VA (US)

(21) Appl. No.: 17/902,825

(22) Filed: Sep. 3, 2022

(51) Int. Cl. H04L 67/12

(52) U.S. Cl. CPC H04L 67/12; G16Y 40/35

(57) ABSTRACT

Next generation intelligent IOT system is invented and described.

### CROSS-REFERENCE TO RELATED APPLICATIONS

This application is a continuation-in-part of application Ser. No. 16/605,191, with a PCT (PCT/US2019/042729) filed on Jul. 22, 2019, which claims priority of 62/701,837 filed on Jul. 22, 2018. This application claims priority to provisional application Ser. No. 63/240,965, entitled “A wireless system” and filed on Sep. 5, 2021; This application also claims priority to provisional application Ser. 63/325,613 entitled “IOT Networks” and filed on Mar. 31, 2022; This application also claims priority to provisional application Ser. No. 63/353,816, entailed “An IOT System” and filed on Jun. 20, 2022; This application also claims priority to Chinese patent application Ser. No. CN202210571576.8 filed on May 24, 2022 with a title of “Internet of Things Data Application and Deep Learning Method”. The entire contents of these applications are hereby incorporated by reference.

### TECHNICAL FIELD

This disclosure relates to the Internet of Things system.

### BACKGROUND TECHNIQUE

At present, the Internet of Things technology has not yet achieved the interconnection of all things. The Internet of Things system in related technologies still has high latency, high power consumption, and network coverage. Problems such as incompleteness, low data load, insecure data, and failure to effectively allocate communication resources in application terminals are obstacles to the development of the Internet of Things technology.

### DESCRIPTION OF DRAWINGS

FIG. 1 is the design schematic diagram of the communication network in the Internet of Things;

FIG. 2 is the composition diagram of the Internet of Things;

FIG. 3 is a global relationship diagram of the Internet of Things;

FIG. 4 is a schematic diagram of communication between terminals;

FIG. 5 is a schematic diagram of timing communication between terminals using different frequency channels;

FIG. 6 is the overall architecture diagram of the Internet of Things;

FIG. 7 is a schematic diagram of a communication network;

FIG. 8 is a schematic diagram of communication resource coordination;

FIG. 9 is a schematic diagram of a communication link in the Internet of Things;

FIG. 10 is the overall architecture diagram of the data intelligence fusion platform;

FIG. 11 is a schematic diagram of an edge computing decision loop;

FIG. 12 is a communication network flow and system relationship diagram;

FIG. 13 is an example diagram of an Internet of Things business flow.

### DESCRIPTION OF THE INVENTION

The IoT system in present invention is based on the multi-mode heterogeneous network, which is specially created for the smart twin/smart empowerment of various industries. The multi-mode heterogeneous network is an effective improvement of the existing wireless communication and network with a variety of networking methods and dynamic coordination allocation of network resources, to achieve ubiquitous, dynamic, real-time effective communication, to improve the utilization of spectrum and network resources, and increase the coverage capacity and performance of the network. Among them, ubiquitous mainly refers to the widespread and ubiquitous network. It is impossible for the operator network to realize ubiquity based on its profit-making nature, while the multi-mode heterogeneous IoT can be built according to the location and needs, that is, it can be deployed in the required location. Corresponding multi-mode heterogeneous base stations. For example, in the Daxing'an Mountains, the coverage of operator networks in forest areas is almost non-existent, and it is impossible to achieve large-scale deployment of operator networks. However, multi-mode heterogeneous base stations can be deployed to cover target areas. Low-cost requirements, a single base station requires a large coverage area (corresponding to longer communication distances), and the base station group only provides a limited overall bandwidth. Second, dynamic means that the network is dynamically variable. Dynamically adjust any communication parameters to establish a network according to industry requirements or/and physical location. In addition to mainstream communication modes, it also includes advanced networking methods such as Mesh, relay, and SDN. Finally, real-time refers to the delay of communication. Real-time is relative. In different communication scenarios, the real-time delay is not the same. In order to meet the above three situations, the concept of multi-mode heterogeneity is proposed.

As shown in FIG. 1, B is dynamically determined according to A. Among them, A includes three situations: (1) the needs of the industrial industry (2) the environment in which the terminal, gateway, and base station are located (such as: time, location, task, channel, etc.) (3) the conditions of the terminal, gateway, and base station itself (such as: energy, noise, interference, etc.). B further includes data, communications, networks, and the like. Specifically, in the first case, the demand of the industrial industry means that different industries have different requirements for communication. For example, the environmental protection industry has the needs of the environmental protection industry, the safety supervision industry has the needs of the safety supervision industry, and the water conservancy industry has the needs of the water conservancy industry. Their needs are different, that is, due to the different content to be delivered, the corresponding communication and network are also different. In the second case, the environment where the terminal, gateway, and base station are located refers to the physical environment, that is, the physical environment where the terminal, gateway, and base station are located, which further includes time, place, task, and channel. In the last case, the conditions of the terminal, gateway, and base station include their own power, sensor value, and sensor value conversion rate. A dynamically determines B. Typically, parameters such as communication interval, transmit power, and modulation mode are adjusted. If the terminal's own battery is low, the sensor value is lower than the set threshold, or the sensor value changes slightly, the transmission frequency will be reduced. Further, as shown in FIG. 1, the data in B indicates how to collect data, what data to collect, how to process data, how to use data, how to transmit data, etc., and communication indicates what communication settings, radio frequency parameters, radio frequency parameters, etc. are used for transmission. Send and receive mode, etc., the network indicates what networking mode, transmission path, etc. are used in the transmission process. Different communication requirements determine different communication strategies, such as high-quality communication requirements, strategies such as data information splitting-multipath concurrency-aggregation, real-time optimization of communication settings and RF parameters, and construction of high-priority networks through core networks and base stations can be adopted, and can be dynamically allocated in actual situations.

The next-generation artificial intelligence IoT system covers multiple levels: from bottom to top, it is the terminal layer, the transmission layer, the support layer, the artificial intelligence business platform layer and the integrated IOC layer for city operations. In addition, the next-generation artificial intelligence IoT system also includes: a security management platform, a unified operation and maintenance management platform, and IT resource services; wherein, the security management platform and the unified operation and maintenance management platform vertically run through all levels, providing full-chain, end-to-end terminal services; IT resource services provide services for the support layer, the artificial intelligence business platform layer and the integrated IOC layer of city operations.

The present invention will be further described below in conjunction with the accompanying drawings and embodiments:

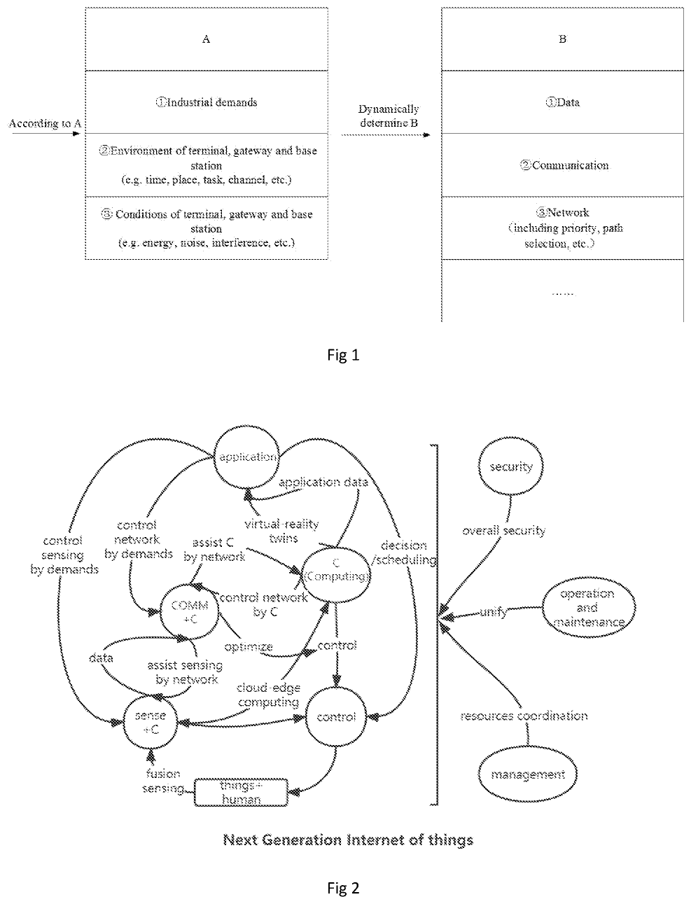

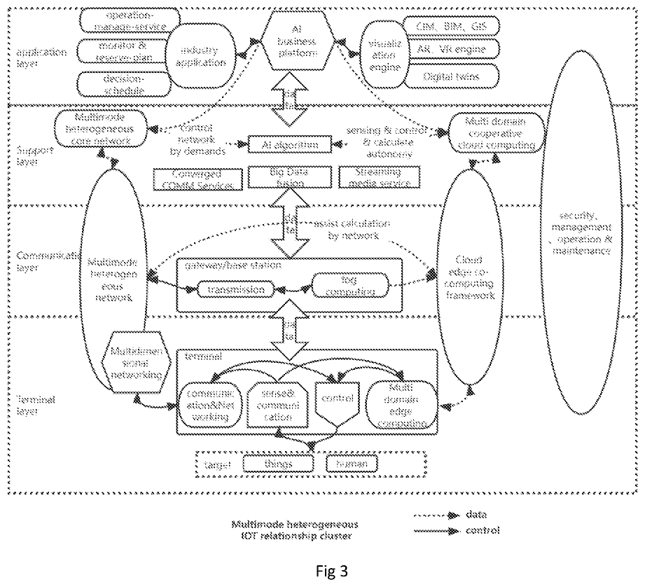

Please refer to FIG. 2 and FIG. 3 together, the terminal layer contains thousands of terminals of different industries and different types of sensor, linkage, multi-mode heterogeneous communication, mobile and/or video. Among them, the sensing terminal can sense the multi-dimensional state of the city in ubiquitous, real-time and dynamic manner, such as water, gas, electricity, soil, sound, fire, etc. The sensed data is multi-mode heterogeneous by dynamically adjusting any communication parameters according to industry requirements or/and physical location. The network uploads to the central platform. Further, the sensing terminal can be various sensors with data collection function or electronic devices with sensors, for example, it can be temperature sensor, smoke sensor, atmospheric pressure sensor, sound wave sensor, image sensor, camera and so on.

In this embodiment, the linkage terminal can realize the linkage that is perceived and executed by the edge side based on a multi-mode heterogeneous network that dynamically adjusts any communication parameters according to industry requirements or/and physical locations, such as linkage alarm, linkage call, linkage control valve/door, linkage SMS/mail notification, etc. Multi-mode heterogeneous communication terminals provide transmission and interconnection dynamically adjusted according to industry requirements or/and physical locations for sensors that do not have the ability to communicate. It supports composite sensing technology, multi-sensor data fusion, and supports unified access of sensing devices from different manufacturers. Sensor technology combined with edge computing technology realizes edge correction and self-correction of perceptual data, and derives an optimized sampling strategy. Typically, the sampling interval and sampling accuracy are dynamically changed according to the rate of change of perceptual data, preset thresholds, and network conditions. and sending frequency, etc., so it can take into account the response time, power consumption of the whole machine, and network bandwidth occupation at the same time. Further, the edge computing method includes: collecting data by several sensing terminals; judging whether the data collected by the sensing terminals is abnormal; when abnormal, the first device connected to the sensing terminal generates first alarm information, and the first alarm The information is sent to all second devices connected to the first device; the second device sends second alarm information to all alarm devices connected to the second device. Wherein, both the first device and the second device may be edge devices or may also be intermediate devices. In this embodiment, the edge device may be used for data packet transmission between the access device and the core/backbone network device, and may be switches, routers, routing switches, gateways, IADs, and various MAN/WAN and other equipment. With the addition of edge computing, the data collected by the sensing terminal does not need to shuttle between the local and central servers, allowing the local device to know which function to perform. This saves operating costs and investment in storage equipment. In addition, edge computing or fog computing or algorithm platform is used to determine the information that needs to be uploaded by communication terminals (such as sensing terminals or gateways or base stations) and its matching communication and network. The information may include but is not limited to the collection of sensing terminals. The data difference value, feature value of the data and/or the feature value of the image and video. It should be understood that the matched communication and network are output by the dynamic deployment of the multi-mode heterogeneous network. For example, when the data difference of the data collected by the sensing terminal exceeds the threshold range, or conforms to a specific image or video feature value, or conforms to a specific sound wave feature, it can be determined that the collected data is abnormal, and then an alarm message and an alarm message are generated. Perform other further operations (at the same time, the multi-mode heterogeneous network dynamically allocates network and communication resources). When the collected data is not abnormal, the sensing terminal can reduce the frequency of collecting data, and transmit it through the matching communication and network, which reduces the waste of communication resources and saves the energy of the communication terminal.

Mobile terminals include handhelds, walkie-talkies, vehicle-mounted devices, positioning terminals, wearable terminals, etc., which perceive, apply, and communicate in a mobile state, through a multi-mode heterogeneous system that dynamically adjusts any communication parameters according to industry requirements or/and physical locations. The network realizes the application of the combination of wide, medium and narrow band, and the integrated communication of voice/video/text/picture/data/file. Video terminals include cameras, thermal imaging, hyperspectral and other diverse video sensor terminals, which are uploaded through a multi-mode heterogeneous network that dynamically adjusts any communication parameters according to industry requirements or/and physical locations.

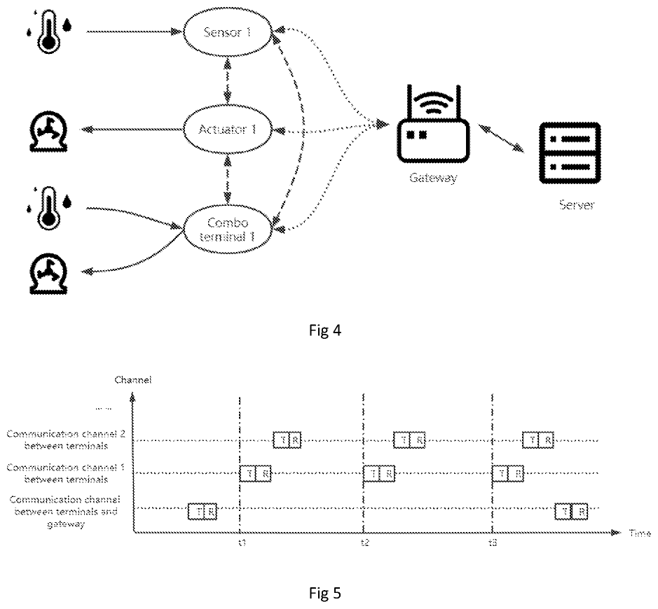

Further, as shown in FIG. 4, all terminals in the terminal layer (including: sensing, linkage, multi-mode heterogeneous communication, mobile and/or video terminals) establish communication By establishing direct communication between the two terminals, any terminal can obtain the sensing data of other terminals, and can make decisions and generate execution commands based on the sensing data of multiple terminals, that is, the sensing data can be comprehensively and comprehensively generated to generate decision-making results, so as to make decision-making possible. The results are more reliable, and even in the case of a gateway network failure, the sensing terminal can still obtain data from other terminals based on direct communication between terminals for edge computing and then generate execution commands under specified conditions, that is, network failures will not affect decision-making. Generation of results. Further, the communication mode between the terminals is different from the communication mode between the terminals and the gateway. For example, different communication channels, modulation methods, synchronization bytes, etc. are used between the terminal and the terminal and between the terminal and the gateway; the payload content transmitted between the terminal and the terminal can use different protocols; the communication between the terminals can use different channels (It may also include different modulation methods, data rates, coding methods, etc.), as shown in FIG. 5, so as to reduce the conflict with the communication between the terminal and the gateway.

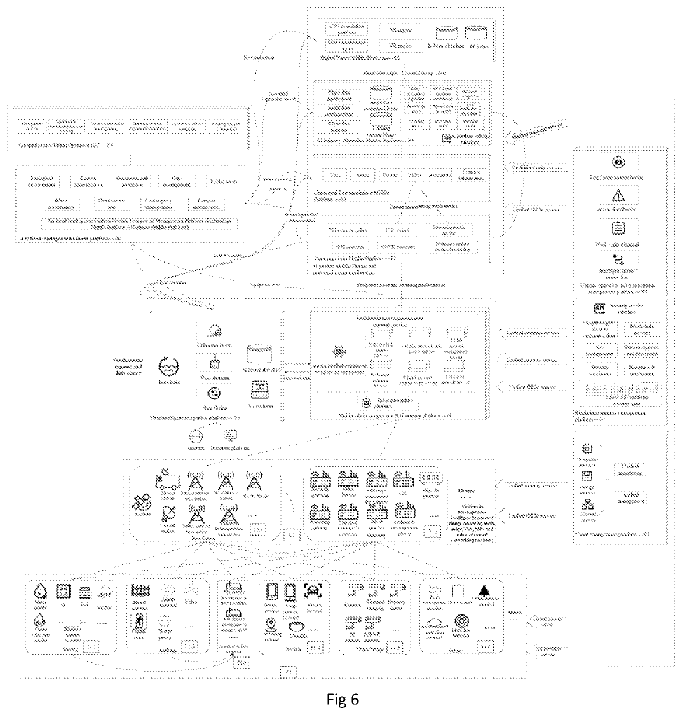

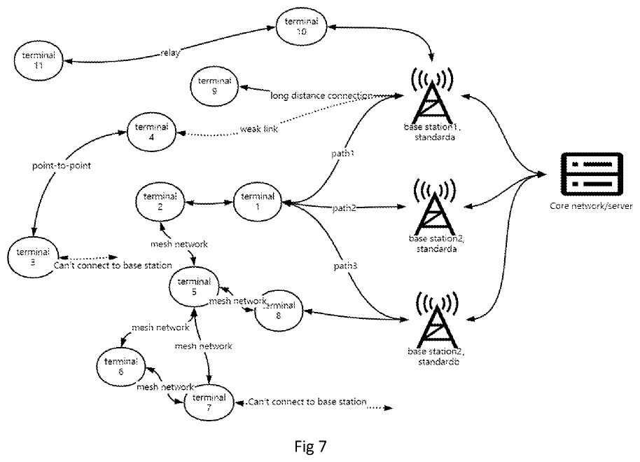

Please refer to FIG. 6 and FIG. 3 together, the communication layer/transport layer is a multi-mode heterogeneous intelligent Internet of Things composed of two major parts: base station and gateway, and any communication parameters are dynamically adjusted according to industry requirements or/and physical locations to establish The network, in addition to the mainstream communication modes, also includes advanced networking methods such as Mesh, relay, and SDN, providing network support for fixed-mobile convergence, wide-medium-narrow combination, and voice/video/text/picture/data/file convergence communications for the terminal layer. The communication layer/transport layer can be understood as the root of the tree, which is the bridge connecting the tentacles and the trunk of the big tree. The transmission layer uploads the sensing, control, status and other information of the tentacles to the support layer (the trunk of the tree) by wireless/wired.

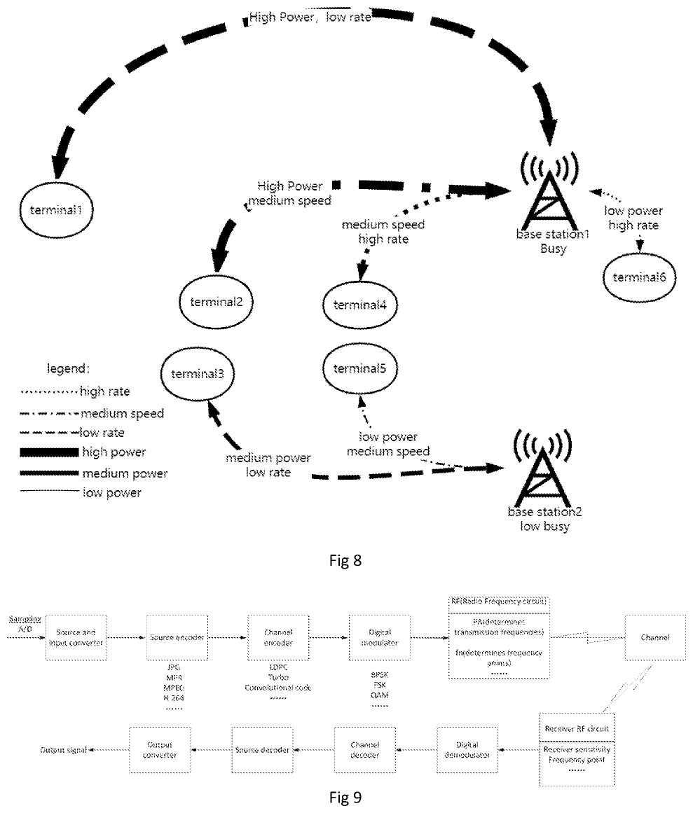

Further, the base station covers various communication networks such as satellite, private network, WLAN, bridge, public network, multi-mode heterogeneous network, etc., and dynamically adjusts any communication parameters to establish a network according to industry requirements or/and physical locations. For example, data splitting and aggregation that supports multi-path transmission. As shown in FIG. 7, the terminal splits the sent data packet into multiple data sub-packets, different data sub-packets are transmitted through different communication methods and different paths, and are spliced into a complete data packet after aggregation at the receiving end. In the figure, terminal 1 has a multi-mode communication mode, and can connect to three base stations of different standards: base station 1, base station 2 and base station 3 at the same time. When transmitting data and through three base stations at the same time, data aggregation and splicing are performed on the core network/server side. Different strategies are used according to the needs of multi-path transmission. For example, when the blind area device cannot be directly connected to the base station, a mesh network can be established with other devices, and uplink communication can be realized with the help of devices that can be connected to the base station: as shown in FIG. 7, terminal 6 and terminal 7 pass between A mesh network is established, and terminals 5 and 8 are connected to the base station. Terminal 5, Terminal 2 and Terminal 8 undertake routing functions. The device can switch between star network and mesh network; when working in mesh network mode, the terminal can be used as a routing node or a common node. The communication network supports point-to-point intercommunication between devices and reduces the bandwidth occupation of the base station. The core network and base station can collect link information of base stations, routing nodes, and terminals, including: communication standard, communication path, signal-to-noise ratio, packet loss rate, delay, channel occupancy rate, etc. Better networking and communication solutions, adaptively adjust the connection mode (directly connected base station, mesh network, point-to-point) and transmission path (single path) of equipment as needed (data transmission rate, response time, reliability, connection distance, etc.), multipath), communication parameters (modulation mode, rate, spectrum occupancy, receiving bandwidth). For example, as shown in FIG. 8, it provides a method to achieve network coordination only by adjusting power and rate. The higher the power, the longer the transmission distance, but the larger the signal coverage during the transmission process, the more likely it will affect the communication of other nearby devices. In the figure, there are many devices connected to base station 1, which are relatively busy, while the devices connected to base station 2 are relatively idle. In order to reduce the busyness of base station 1, terminal 2 and terminal 4 use high-power and high-speed transmission, and the transmission process may affect base station 2, because base station 2 is relatively idle and can accept this effect. The terminal 3 and the terminal 5 transmit through the base station 2 with low power and low rate as much as possible, and the influence on the base station 1 is small because the power is small. Terminal 1 can only transmit with high power and low rate because it is far away, while terminal 6 can transmit with low power and high rate because it is close enough to base station 1.

In this embodiment, the gateway includes different types such as edge AI, security, positioning, video, mid-range communication, CPE, RFID, technology detection, etc., and can realize network interconnection with different high-level protocols, including wired and wireless networks. Industry requirements or/and physical location dynamically adjust any communication parameters. The gateway supports the connection of various terminals in various connection modes, including LPWA, Ethernet, Wifi, and other wired and wireless connections (such as Bluetooth, Zigbee, and private wireless communication, etc.) extended through the gateway motherboard. Local terminals in different connection modes have independent identification numbers, and are managed and communicated in the same way as normal terminals. The gateway also has the function of communication network service, which can maintain normal communication in the case of disconnection, and can automatically synchronize status and data with the server after networking. The gateway has an edge computing framework, which can configure edge computing functions arbitrarily, realize data cleaning, aggregation, calculation and decision-making locally, and can directly issue decision-making instructions locally to the designated terminal at the terminal layer. Further, the gateway supports a display screen, which can directly display the system status and data reports generated by edge computing, and also provides user interaction functions such as camera and audio to realize edge multimedia applications. Further, in the embodiment of the present invention, the base station/gateway may have its own distributed edge core network (or communication server), and can automatically switch to the edge core network when the connection with the server core network is interrupted; The base station/gateway can be networked by wireless or wired, and one base station/gateway is used as the core network. The edge core network provides layered and regional communication in the case of disconnection and weak network, and provides the necessary support for data exchange for sub-domain edge computing.

The support layer is the core of the next-generation artificial intelligence IoT system, which can be understood as the trunk of the big tree. All data and services required by the upper-level business are provided by the support layer. Various data such as sensor and control at the root of the tree will enter the crown and branches through the support layer. In the present invention, the support layer mainly includes a multi-mode heterogeneous IoT sensor platform, an intelligent data fusion platform, a digital twin platform, an artificial intelligence industry algorithm platform, a converged communication platform, and a streaming media platform. The above platforms will be described in detail below with reference to the accompanying drawings.

Further, the multi-mode heterogeneous IoT sensor platform is used to aggregate the data of the terminal layer and the transmission layer, support the device management of the terminal layer and the transmission layer, and provide dynamic adjustment of any communication parameters according to industry requirements or/and physical locations. multi-mode heterogeneous network services and edge computing services. Among them, multi-mode heterogeneous network services not only provide separate access and management services for different network communications such as existing satellite links, cellular network links, RFID network management, LTE core network, WLAN network management, and LoRa core network; The wireless access service of the multi-mode heterogeneous core network supports the converged access and unified management of the multi-mode heterogeneous wireless network. Multi-mode heterogeneous network services provide network services that dynamically adjust any communication parameters according to industry requirements or/and physical locations, such as adjustable source coding, channel coding, modulation model, signal unit time slot, transmit power and other physical communication parameters; also The wireless link access and management technology with flexible scheduling and expansion can perform functions such as remote control, upgrade, parameter reading/modification, and management of equipment, support link self-healing, and provide high utilization, strong stability, and easy recovery. Professional wireless network hosting services. For example, please refer to FIG. 9, which is a schematic diagram of a multi-mode heterogeneous communication link in the next-generation IoT. As shown in the figure, the data is first sampled, and the sampling interval can be set according to the requirements (for example, it can be sampled once in 1 minute, or once in 1 second). Then perform A/D conversion on the sampled data, and convert the analog data into digital data. The precision of the A/D conversion can also be set according to needs: it can be 8 bits, 12 bits, 16 bits, 24 bits, etc. The digital data is then transmitted through the RF (radio frequency circuit) after the source code is used for source coding, the channel code is used for channel coding, and the digital modulator is used for digital modulation. Among them, the source coding technology itself is very mature, mainly reflected in a set of standard protocols to realize its functions, these protocols include MPEG-1, MPEG-2, MPEG-4 and H.263, H.264, H.265, etc., they are mainly formulated and completed by the two major international standardization organizations ITU-T and MPEG, and the most used protocols are MPEG-4, H.264 and H.265. The types of channel coding mainly include: linear block codes, convolutional codes, concatenated codes, Turbo codes and LDPC codes. Digital modulation methods include: FSK (Frequency Shift Keying), QAM (Quadrature Amplitude Modulation), BPSK (Binary Phase Shift Keying) and so on. The above coding and modulation methods are all in the prior art, and will not be described in detail here. Multi-mode heterogeneous network services provide network services that dynamically adjust any communication parameters according to industry requirements or/and physical locations, such as adjustable source coding, channel coding, modulation model, signal time slot, transmit power and other physical communication parameters. For example, the transmit RF signal can be adjusted by PA (determines the transmit power) and fn (determines the transmit frequency). Exemplarily, the adjustment includes allocating different transmission bandwidths to different services. When the data transmission requirements of some terminals change, the multi-mode heterogeneous network adjusts the distribution of network resources to adapt to the changes in requirements. Illustratively, the adjustment includes priority adjustment of signal transmission. For example, the signals of some terminals are preferentially transmitted. For example, data of some base stations or gateways are preferentially transmitted. For example, some service signals of the terminal are preferentially transmitted. The multi-mode heterogeneous network adjusts network parameters in a timely manner based on on-site sensor and service requirements, which can ensure the implementation of important upper-layer services and improve the availability of the multi-mode heterogeneous network. Further, the adjustment includes dividing different data into different data streams and transmitting them through different communication paths. For example, part of the data is transmitted to the upper-layer service through the 4G network, part of the data is transmitted to the edge computing module through the LoRa protocol, and part of the data is transmitted through the customized multi-mode heterogeneous communication network protocol. The consumption of network resources is reduced as much as possible, and the communication and network can be dynamically adjusted in real time according to changing business requirements. In addition, edge computing services are aimed at accessing multi-mode heterogeneous networks, providing dynamic and adaptive network allocation with edge computing capabilities of converged networks, and providing different delays that adapt to the needs according to different industry needs and different physical environment needs. Time, different bandwidth, different time slot network, dynamic, automatic and reasonable allocation of communication and network resources. For example, the environmental protection industry requires data sampling on time and reporting low latency, but thousands of sites report data at the same time, and the concurrency of sending data at the same time is high, but the time interval between two adjacent reports may be long, which requires our Edge computing services provide support, dynamically and reasonably allocate network resources, such as deploying other non-time-sensitive devices to avoid, such as temporarily deploying multiple communication channels, such as site sampling on time but uploading at the wrong time.

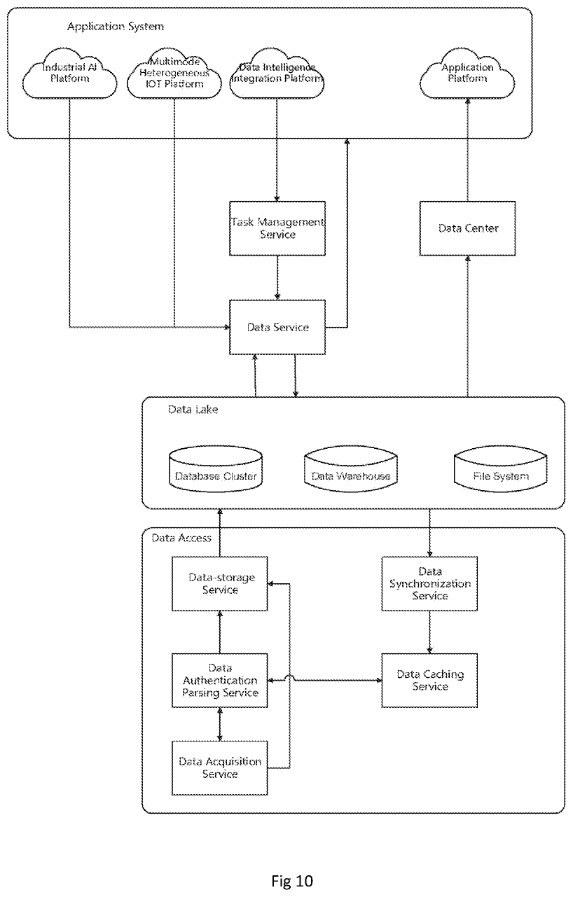

Further, as shown in FIG. 10, the data intelligent fusion platform is used to provide cross-department and cross-industry data collection and aggregation, data cleaning, and data fusion including structured, semi-structured, and unstructured multi-source heterogeneous data, resource catalog and data sharing exchange services. Among them, data aggregation can be connected to the sensing data uploaded by the multi-mode heterogeneous IoT sensing platform, other third-party platforms or data shared by the upper and lower platforms, and unified aggregation to form a data lake. The data lake also aggregates business data/control data/algorithm warning data/data required by different industries/physical location data that are generated or need to be interacted with other sections (business section, other support sections). Data cleaning, fusion, and resource catalogs mainly manage and classify the aggregated data, form various subject libraries, thematic libraries, etc., to facilitate the extraction of data from different businesses, and serve as a digital twin center, artificial intelligence industry algorithm center, and converged communication center. Support platforms such as streaming media platforms and artificial intelligence business platforms provide the data they need. Data sharing and exchange, providing data sharing and exchange with third-party platforms and upper and lower platforms. In this embodiment, the data lake warehouse is composed of a database cluster, a data warehouse and a file system. The database cluster mainly stores business data to ensure daily business flow, and the data warehouse stores the collected raw data and the data ETL (extraction) based on the data; conversion, loading), data governance, and data mining result data, the file system mainly stores unstructured data files including database backup files; data services are based on a complete set of data systems implemented on top of the data lake warehouse, including application systems for Any operation of the data lake warehouse, and provide service support to the business platform. In general, the data intelligent fusion platform can realize multi-industry access, including air, meteorology, soil, transportation, construction, water quality, fire insurance and other multi-industry data including environmental protection, fire protection, municipal administration, etc. Fusion to break through industry barriers; at the same time, the data intelligent fusion platform also provides multi-source heterogeneous data access, including data sources such as databases, file systems, message queues, and structured, semi-structured and unstructured data sources. Data sources can be Unlimited expansion, data capabilities can be replicated indefinitely, providing huge data resources for various business scenarios; its data specifications are unified, providing a unified data dictionary and data specifications, reducing development costs and improving data quality. It should be understood that, precisely because of the network communication data transmission between the multi-mode heterogeneous IoT network and the data intelligent fusion platform, the continuous access and downlink of data in different formats in the data intelligent fusion platform is dynamically realized. operation, so that the data sources in the data lake of the data intelligence fusion platform can be expanded infinitely, and the data capabilities can be replicated infinitely, providing huge data resources for various business scenarios. In this embodiment, the data sources in the data lake of the data intelligent fusion platform include: data of the sensing terminal, communication big data, external data, and data generated by the algorithm middle station, and the like.

Further, the functions of the streaming media platform mainly include two parts: the first is to provide video recording, PTZ control, streaming media, SDK, ONVIF, national standard agreement and other services support the artificial intelligence business platform. In addition, the interaction between the streaming media platform and the data intelligent fusion platform includes that the streaming media platform receives information such as video, pictures and streaming media access from the data intelligent fusion platform, and the streaming media platform feeds back control information, screenshot information, etc. to the data intelligent fusion platform And stored in the corresponding theme/topic library. The streaming media platform supports sending control commands to terminals in corresponding industries and physical locations through a multi-mode heterogeneous network to realize terminal control. In this embodiment, the access layer of the streaming media platform is responsible for the realization of the connection between devices and subordinate domains, as well as the acquisition of original media data, and the information is abstracted and reported uniformly. The core layer is responsible for the unified management and control of devices and services, shielding the differences between different access methods, and providing core APIs (such as streaming, recording, PTZ control, and device control). Cascading layer services are connected to upper-level domains. The application service layer handles business logic and permission control. The streaming media platform supports multi-protocol access (GB/T28181, ONVIF, various SDKs, network video streaming, live streaming); supports multi-protocol playback (RTSP, RTMP, FLV, HLS). It can adapt to various network environments (such as multi-mode heterogeneous networks), dynamically configure policies to control when the flow is disconnected and when to start, and supports screenshot plans and video plans; it can be connected to algorithms to deeply mine data, and at the same time, the Streaming media platform supports national standard platform cascade, supports GA/T1400 view library.

Further, the converged communication middle station provides a multi-mode heterogeneous network that dynamically adjusts any communication parameters according to industry requirements or/and physical locations to achieve text, voice, pictures, videos, locations, attachments and other different types of data or files. Converged Communication Services. Converged communication services include the uplink and downlink of data, the uplink includes the upload of different types of data and files, and the downlink includes the download of different types of data and files to terminals in corresponding industries and/or physical locations. Its main services include: (1) Provide integrated communication services of different types of data or files such as text, voice, pictures, videos, locations, attachments, etc., to support the artificial intelligence business platform. For example, in addition to voice, voice chat also supports the sending and receiving of different types of data and files, while event reporting supports the use of text, and additional information such as voice, video, pictures, location, or attachments. (2) Access to data such as text, voice, pictures, video, location, and files provided by the data intelligent fusion platform. The data of the data intelligent fusion platform comes from the multi-mode heterogeneous network of the terminal and communication layer. It supports to feed back the data generated by the fusion communication to the data intelligent fusion platform and store it in the corresponding theme/topic database. (3) For video-based converged communications, the streaming media platform provides camera control, streaming media services, etc. for the converged communications middle station. Some control information can be downlinked to the terminal corresponding to the industry and the corresponding physical location through the multi-mode heterogeneous network. In general, the converged communication platform can be understood as an interactive system (data types include video, voice, text, pictures, locations, files, etc.), data is bidirectional, and data can be circulated between the platform and the terminal and/or, between terminals and terminals, and between multiple terminals and platforms (similar groups). The streaming media platform mainly focuses on data upstream collection and downstream control of cameras. The integrated communication platform of the present invention realizes comprehensive sensor, information fusion, instant communication and intelligent control through the interconnection of “people to people”, “things to people” and “things to things” (based on a multi-mode heterogeneous network).

Further, the artificial intelligence industry algorithm middle platform is used to provide management services such as algorithm deployment, algorithm configuration, algorithm training, and algorithm viewing/importing/deleting/upgrading for artificial intelligence algorithms. The input parameters or video sources of the artificial intelligence industry algorithm platform come from the multi-mode heterogeneous network aggregation and uploading dynamically allocated according to industry requirements or/and physical locations, including various sensors, alarms, video data, etc. At the same time, the linkage control, linkage call, linkage alarm, linkage SMS/email notification and other data generated by the artificial intelligence industry algorithm center are dynamically downloaded to the corresponding terminal through the multi-mode heterogeneous network according to industry requirements or/and physical location. In this embodiment, the artificial intelligence industry algorithm center supports unified management and operation and maintenance of computing power and service resources, and can implement fog computing, edge computing and artificial intelligence according to industry applications, computing power, network and communication conditions. The computing power of the platform in the industry algorithm and the dynamic allocation of algorithm tasks. The containerized cluster mode is adopted to support the flexible scheduling of computing resources. According to the actual configuration scenario and the dynamic allocation of multi-mode heterogeneous communication networks, it can automatically expand and shrink, and improve the utilization of computing resources. Secondly, the artificial intelligence industry algorithm middle station can access the input parameters and video data required by different algorithms uploaded by the data intelligent fusion platform, and can output alarms/eigenvalues, etc. to the artificial intelligence business platform, so as to realize artificial intelligence-based and algorithmic warning view. In addition, the alarms/feature values generated by the AI industry algorithm center will also be fed back to the data intelligence fusion platform and stored in the corresponding theme/topic library. For example, for video-based algorithms, the AI industry algorithm center can retrieve the required videos/pictures through the streaming media center. For example, for prediction algorithms such as fire spread prediction and gas diffusion prediction, it is necessary to display the predicted diffusion range after a period of time (for example, one hour) in a three-dimensional form. In such cases, the artificial intelligence industry algorithm center will provide data such as eigenvalues and prediction simulations to the digital twin center described below.

The method for implementing mirroring in the artificial intelligence industry algorithm of the present invention is described in detail below:
The self-iteration steps of implementing the mirroring algorithm in the algorithm center include:
First, upload the algorithm image to the algorithm center;
Then, based on the algorithm image, install the corresponding algorithm instance in the artificial intelligence industry algorithm platform;
Running an algorithm mirroring service based on the algorithm instance;
Collect negative samples of running algorithm mirror service production data;
Then, retrain the algorithm image to improve the model accuracy and generalization ability, and produce a new algorithm image.
The algorithm center provides external processing capabilities through APIs or push messages.

In general, the artificial intelligence industry algorithm platform of the embodiment of the present invention takes the computer vision algorithm as the core, the algorithm model covers the mainstream industry, supports the rapid deployment, management, and integration of the massive mature algorithms in the demonstration platform, and is suitable for any algorithm. In scenarios where the model has automation requirements, through a unified portal, integrated computing resources are provided, services are shared, and development costs are reduced. It is suitable for scenarios that require centralized management and maintenance of algorithm models, provides standardized API interfaces and documents, and develops standardized AI capabilities. The artificial intelligence industry algorithm middle-end can be standardized and platform-based management, the integration is simple, and the development process is simplified; it provides an operation and monitoring mechanism for the algorithm model to ensure the stability of the service provided by the model; provides access to the algorithm data set. Unify channels, standardize and unify data format standards; provide a unified evaluation index system for algorithm models to reflect the generalization ability of algorithm models on the platform; perform data aggregation and analysis on algorithm calculation results; The model can also provide a system for continuous improvement and iterative model quality; it has the whole-process management of algorithm model generation and optimization; it provides a system for operation and maintenance management and performance evaluation of algorithm models, and dynamically allocates and manages computing resources; As an independent middle-end product, it provides external service capabilities, and conducts statistical analysis on the resources, data and operation of the provided services and instances.

Further, the digital twin platform is based on the dynamic sensor data of different industries and different locations uploaded by the multi-mode heterogeneous network, and provides the city 3D twin service for the artificial intelligence business platform. The CIM, AR, VR, BIM, GIS, etc. required by the artificial intelligence business platform all need the support of the digital twin platform. In this embodiment, the data generated by some modifications and definitions of the map, layers, key points, etc. made by the digital twin platform will also be fed back to the data intelligent fusion platform and stored in the corresponding theme/topic library. The digital twin mid-stage of the embodiment of the present invention provides synchronization and operation mapping capabilities between various types of entity devices and twin models; provides a mid-stage architecture and implementation method for the general capabilities of digital twins; Dimensional performance-balanced technical architecture; provides the capability of unified management of AR engine, VR engine, and CIM visualization engine, and the ability to provide services through integrated publishing. Specifically, the digital twin middle-end provided in an embodiment of the present invention is a middle-end that provides a unified digital twin service, and provides CIM model engine support and interaction layer docking for the business system.

Further, the AI business platform layer displays, analyzes, predicts, forecasts, and rehearses data from different industries and different physical locations uploaded by the multi-mode heterogeneous network, providing AI-based unified module component management and the wisdom of different industries. Application, receive the data of each support platform, and feed back the operation information of the business side to each support platform. At the same time, some operational data can be dynamically adjusted according to industry requirements or/and physical location, and sent to the terminal through the communication layer to achieve linkage. Specifically, the artificial intelligence business platform layer provided by an embodiment of the present invention includes: an organization management module, a user management module, a role management module, a rights management module, a log management module, a special project module, and a general component library module. The artificial intelligence service platform layer provided by an embodiment of the present invention can flexibly and quickly configure cross-application, cross-system, and cross-role projects through unified authentication, and establish a unified authentication center and authentication gateway from a business perspective. Through the decentralized authentication method, the bottleneck of authority reuse and unification of various technology middle-end and business platforms is broken. In a nutshell, through the unified authentication of the present invention, cross-application, cross-system, and cross-role projects can be flexibly and quickly configured; by decoupling and stripping business modules, each independent module supports asynchronous development, reducing the overall situation in the development process. problems and improve development efficiency; through a unified public technology module, a service is formed by separation, and when the service is needed again, it is completed through an interface call, which avoids the lengthening of the research and development cycle, and saves development time and resource sampling business processes. Modules are encapsulated into public business process modules, which can be directly reused when encountering the same business process scenarios, reducing trial and error costs; solving the pain points of many project R&D links, inability to integrate uniformly, and lack of uniform development standards and operation and maintenance mechanisms; implementation technology The integrated application of, business and data can reduce research and development costs, realize rapid business response, data accumulation, and efficiency improvement.

Further, the integrated IOC layer of urban operation is used to synthesize the data of various industries to realize the overall situation overview of the city, monitoring and early warning, command and dispatch, event handling, operation decision-making, etc. The city operation integrates various aggregation and downlink data bridges/supports at the IOC layer, relying on a multi-mode heterogeneous network established by dynamically adjusting any communication parameters according to industry requirements or/and physical locations. The comprehensive IOC layer for urban operation provided by the present invention is suitable for the comprehensive operation scenarios of cities at the district and county level, prefecture level, provincial level and ministerial level, and is suitable for hierarchical deployment of departments at all levels, forming a cascade of urban big data dynamic monitoring and early warning, urban Plan management, hierarchical event handling, big data operation decision analysis and leadership hierarchical management decision-making. In addition, the integrated IOC layer for urban operations is suitable for accessing and converging data and processes of various government agencies, enterprises and institutions, and for unified data cleaning, data normalization, early warning rule definition, and monitoring and early warning. It is suitable for various secure network environments, providing secure data access management and comprehensive urban operation functions. It is suitable for use by departments and personnel of government commissioned units, enterprises and institutions at all levels. It is suitable for centralized deployment and distributed deployment environment, suitable for different user groups and various complex flow processes. Specifically, the urban integrated operation IOC platform provided by an embodiment of the present invention is divided into five components, namely: dynamic monitoring and early warning, plan management, inter-departmental event handling, operation decision analysis, and leadership cockpit. The city operation integrated IOC layer provided by an embodiment of the present invention solves the problem of data island barriers in the existing city integrated operation system products, and integrates the information system data of various industries in the smart city, unifies data standards, and unifies data cleaning. and unified data exchange; the invention solves the problem that the urban comprehensive operation system cannot open up the event handling process between various departments; establishes a closed loop of the urban comprehensive operation function, making the urban comprehensive operation more efficient. Further, as shown in FIG. 6, the functions of the dynamic monitoring and early warning module and the visual command and dispatch included in the integrated urban operation IOC are as follows: Data, artificial intelligence industry algorithm middle-end, and visualization function of digital twin; visual command and dispatch module is used to use converged communication middle-end, and then associate multi-mode heterogeneous core network, use streaming media platform to view camera terminal, use digital twin The platform displays personnel, resources, terminals, etc.

In the present invention, the security management platform starting with multi-mode heterogeneous network security can provide security support for data collection, data transmission, data processing and other steps of each terminal/device in the Internet of Things, and can solve illegal intrusion and data leakage, external attacks, and other issues related to data security; the security system starts with multi-mode heterogeneous network security, and dynamically controls security from the root, instead of only ensuring security at the platform layer. The security management platform provided by the present invention is applied in the multi-mode heterogeneous system as shown in FIG. 6, and is different from the terminal layer (including various sensors, etc.), communication layer (including base stations, gateways, etc.) of the multi-mode heterogeneous system in this embodiment.), the support layer (including the data center, core network, etc.) interacts, so as to carry out dynamic and linkage control of the entire multi-mode heterogeneous system to ensure data security and communication security. The security management platform provided by an embodiment of the present invention is suitable for any scenario where IoT devices are securely connected to the cloud; it is suitable for securely connecting with any type of third-party platform data, providing secure channels and data tamper-proof functions; It can be used in combination with various communication types, that is, to meet the needs of multi-mode heterogeneous networks; it is suitable for scenarios where IoT device data, user-generated data, third-party access data are securely accessed and data is uploaded to the blockchain for protection. The blockchain security management platform of this embodiment is divided into three components, namely security resources, security services, and security management. Among them, the security resource component includes a password resource pool, a key management system, a signature verification system, and a data encryption and decryption system. Configure the cryptographic resource pool in advance, and then establish a key management system, a signature verification system, and a data encryption and decryption system based on the cryptographic resources and encryption/decryption algorithm resources of the cryptographic resource pool. The security management component includes systems such as communication security, network security, data security, situational awareness, emergency response, knowledge graph, and user management. Among them, communication security, network security, and data security provide situational awareness with sensor data of security situation; situational awareness analyzes security situation; situational awareness provides results to emergency response, and emergency response notifies relevant security personnel; then the entire security incident is reported. Store in the knowledge graph for storage and record; the knowledge graph provides the basis for the configuration of communication security, network security, and data security, forming a closed loop. Security service components include lightweight authentication services, security authentication services, and blockchain services. The security service component is based on the security resource component, and under the call management of the security management component, provides security services to the business system and the Internet of Things terminal.

In the present invention, the problem of difficulty in device key distribution and storage is solved. The blockchain security management platform uses the chain formed by ready-made terminals, gateways and base stations, and uses their location (such as longitude, latitude, altitude and other coordinate data), communication parameter information, time information, data packet sequence information and other line data calibration. verification and encryption. The receiver uses the corresponding information to perform reverse checksum decryption. The path (the path is defined by the geographic location information of the gateway through which the data passes) is converted into a key for encryption, and the receiver determines whether the data is legitimate by checking the path information. The recipient needs to know or collect the legal route in advance, or the location information of the legal route point (eg gateway). It should be noted that the data transmission paths are different, the decryption keys are different, the next node knows the location information of the previous node, and the adjacent layers use different keys for encryption and decryption. Alternatively, the decryption may not be performed at the intermediate node, and the layers are encrypted and transmitted to the server or the cloud, and the server or the cloud decrypts the data for multiple rounds. Alternatively, only the first node performs encryption, the intermediate nodes passing through the transmission perform integrity check and digest overlay on the data, and the server or cloud performs reverse integrity check according to the transmission path. information is decrypted. The encryption process starts from the data source (perceptual terminal layer), runs through the communication layer/network layer, reaches the multi-mode heterogeneous core network layer, and then reaches the full coverage of the support layer and application layer, instead of only ensuring security at the platform layer.

The first sensing terminal at the terminal layer needs to transmit Data1 data to the first server, and the first sensing terminal has a unique device ID1, HMAC1 key, and a public-private key pair {NPkey1, NSkey1}; the first server has a public-private key pair. {CPkey, CSkeya}. The first sensing terminal has a real-time clock and latitude and longitude position data, and sends data Data1 to the first server at time T1 and location L1. The encryption process includes: \textcircled{1} encrypting T1 and Data1 with the server public key CPkey to obtain the ciphertext E1; \textcircled{2} using the private key NSkey1 to digitally sign ID1 and E1 to obtain the signature S1; \textcircled{3} using the HMAC1 key to perform a hash operation on E1 and S1 Obtain the hash value H1; \textcircled{4} Send the data ID1, E1, S1 and H1 to the first server for decryption by the first server. It should be understood that the encryption can also be generated at the sensor terminal or gateway, as required.

In some embodiments, each node in the transmission can perform a superimposed hash algorithm on the data. After the server receives the data packet, the server performs a hash algorithm on the information of the sending node and the intermediate node one by one to ensure the integrity of the data. authenticity. In connection with the above example, in step 4, it also includes: the first sensing terminal sends data ID1, E1, S1 and H1 to the first server and passes through several communication nodes in turn, wherein the communication nodes can be gateways, base stations, communication nodes. Continuing and other devices involved in communication. Each node performs a superimposed hash algorithm on the data sent by the previous node: after node m receives the data IDn, En, Sn and Hn sent by node n, it obtains the real-time time Tm and location Lm. Then, the hash value Hm is obtained through the hash algorithm. Finally, the data IDm, IDn, En, Sn and Hm are sent to the next communication node, and so on, and finally the data is sent to the server. The encryption method provided by the embodiment of the present invention ensures the confidentiality, integrity and availability of data, and can resist common communication attack methods. For example, the saboteur obtains data packets by monitoring the communication. Since the data is encrypted at the source of the sensing terminal, the saboteur cannot easily obtain the original data, so it cannot know the content of the data, thus ensuring the confidentiality of the data; When the packet passes through each node, the integrity check value will be recalculated. The receiver will recalculate the integrity check value in the same way. Only when the data sender and all intermediate nodes are correct can they pass. This operation not only ensures the integrity of the data The security also ensures the non-repudiation of the communication node; the saboteur intercepts the data packet and resends the same data packet to the intermediate node (ie, replay attack). Integrity check and decryption will fail and the data packet will be discarded; if the saboteur uses the man-in-the-middle attack method to simulate itself as an intermediate node, since superposition encryption and verification cannot be performed, any changes to the data cannot pass through the receiving end. verify.

Similarly, through all horizontal levels, a unified operation and maintenance management platform that provides full-chain, end-to-end operation and maintenance services can realize unified operation and maintenance of various terminals/devices in the Internet of Things. Tasks such as inspection, alarm dispatch, work order dispatch, work order disposal, and log management; it dynamically controls the status of all devices based on a dynamically adjusted multi-mode heterogeneous network. At the same time, through the dynamic multi-mode heterogeneous network, it can be sent to each terminal according to the requirements, so as to realize functions such as alarming, dispatching work orders, and patrolling. Specifically, an embodiment of the present invention provides a unified operation and maintenance management platform. The unified operation and maintenance management platform may include: a data access module for accessing data information of devices of smart city-related projects from other modules, and The data information is converted into the real-time data and offline data of the equipment that meet the operation and maintenance requirements; the data alarm analysis module is used to analyze the real-time data of the equipment and the offline data of the equipment according to the preset alarm rules, and generate the alarm information of the equipment data and equipment offline alarm information; an operation and maintenance module, configured to maintain the equipment data according to the equipment data alarm information, and maintain the equipment according to the equipment offline alarm information. The solution of the embodiment of the present invention is described in detail below: The unified operation and maintenance management platform of the embodiment of the present invention adopts the unified operation and maintenance technology and the work order processing technology, and reports the data and the equipment of the smart city related projects through the multi-mode heterogeneous IoT sensor platform. The offline data of equipment is operated and maintained in a unified manner, and work orders are automatically generated and allocated according to the status of the equipment, and the work orders are processed and statistically analyzed, so as to realize the operation and maintenance of equipment and equipment data in the whole city. The unified operation and maintenance management platform can be applied to the unified operation and maintenance management platform (R9) shown in FIG. Y2), multi-mode heterogeneous IoT sensor platform (R1), algorithm middle platform and multimedia command system (R4, R5, R6, R7) to provide unified operation and maintenance services. It should be emphasized that the unified operation and maintenance management platform can dynamically control the status of all devices based on the dynamically adjusted multi-mode heterogeneous network. In order to realize functions such as alarming, dispatching work orders, and patrolling. Further, the data information accessed by the data access module in the unified operation and maintenance management platform includes but is not limited to: from the data intelligent fusion platform (R2) shown in FIG. 6, the multi-mode heterogeneous IoT sensor platform (Device upload data, device online status data and camera image alarm data connected to platforms such as R1) and algorithm middle platform (R4). The WEB application microservice sub-module of the operation and maintenance system is specifically used to realize the basic business logic of the unified operation and maintenance platform, including but not limited to: basic management microservices, system management microservices, resource management microservices, alarm management microservices, and operation and maintenance management Microservices, etc. It can obtain device data from the data intelligence fusion platform (R2) shown in FIG. 6, obtain application-usable data from the artificial intelligence business platform (R10), and obtain workflow data from the workflow engine, so as to be compatible with the operation. Maintenance system APP subsystem realizes operation and maintenance management together. The workflow engine here is used to provide basic workflow transfer services for the unified operation and maintenance management platform. In general, the unified operation and maintenance management platform of the embodiment of the present invention has the following advantages: it provides unified operation and maintenance of smart city-related projects, and breaks the limitation of chimney construction of different systems of smart city operation and maintenance. The unified operation and maintenance management platform supports independent operation and maintenance according to different projects. Supports the control of system access according to user permissions. It can integrate the data of various industries to realize the overall situation overview of the city, monitoring and early warning, command and dispatch, event handling, operation decision-making, etc.

IT resource services can provide unified monitoring and dynamic allocation services including computing resources, storage resources, and network resources for the support layer, the AI business platform layer, and the city operation integrated IOC layer according to different needs such as business volume and time. IT resource services provide support for dynamic allocation of communication resources, which can realize unified management of physical devices and physical environments in the Internet of Things, including unified resource management of computing resources, storage resources, network resources, security resources, and monitoring and sensing resources. The IT resource service provided by an embodiment of the present invention is suitable for the installation and deployment of information systems in any industry and the management of equipment rooms in the equipment rooms, for the management of equipment rooms and equipment in data centers of any scale, and for self-built cloud computer rooms and public Management of cloud computer room and equipment room. It is suitable for the management of integrated smart cabinets. It is suitable for on-site and remote cloud platform computer room management. The IT resource service components include: a unified management system, a unified monitoring system, a unified operation and maintenance system, a unified security system, a three-dimensional twin system, and a user management system. In general, the IT resource service provided by an embodiment of the present invention can achieve the following technical effects in combination with multi-mode and heterogeneous application scenarios: the cloud physical environment can be comprehensively monitored. Multi-path and multi-method technology to obtain cloud physical environment parameters. Flexible for any type of cloud physical device. Customized service configuration and keep-alive based on different application scenarios. Remotely perform physical power off, restart and maintenance of cloud physical devices. The cloud physical device is abstracted into a 3D virtual model, and the 3D model operation is mapped to the actual cloud physical device and cloud physical environment monitoring device. The monitoring data is transmitted through active+passive multi-mode. Install, manage and configure services on bare metal cloud physical machines. Unified management of IT resources, providing unified IT resource operation and maintenance services to the outside world, improving the efficiency of operation, maintenance and management. The IT resource service (ie, the cloud management platform) can uniformly manage resources such as memory, hard disk, input/output interface, CPU and/or GPU in the cloud. It can also dynamically expand and manage the computing resources of any interface: it can directly connect the computing resources of physical devices to virtualize them into computing resources, and it can also connect to the virtualization platform to indirectly manage and connect the computing resources of physical devices. It should be understood that what the cloud management platform implements is the deployment and use of computing resources on the platform side. The “edge computing platform” in the multi-mode heterogeneous IoT sensor platform and the artificial intelligence industry algorithm middle platform are used to allocate computing tasks among platforms, gateways/base stations and terminals.

In order to make the purpose, technical solutions and effects of the present invention clearer and clearer, the present invention is further described below in detail. It should be understood that the specific embodiments described herein are only used to explain the present invention, but not to limit the present invention.

The embodiments of the present invention provide an application of the next-generation Internet of Things in the field of forest fire protection. Specifically, the upper-layer business is fire warning and flame detection in the forest fire prevention industry. The following solutions are used to meet business needs: operators in forest areas have poor network coverage, and multi-mode heterogeneous base stations are deployed to cover target areas. Low-cost requirements, a single base station requires a large coverage area (corresponding to longer communication distances), and the base station group only provides a limited overall bandwidth. Sensor devices at the terminal layer include soil sensors, temperature sensors, wind direction sensors, flame detection terminals, and cameras with PTZs, etc. Secure encryption that can be keyed by the communication endpoint characteristics or the communication information (refer to the above embodiments for encryption). Soil sensors, temperature sensors, wind direction sensors, and flame detection terminals have low power consumption, fast response, and small amount of communication data transmission, but long-distance communication is required for many points and scattered deployment; PTZ cameras have high power consumption, slow response, and communication data transmission. large. Infrared sensors can sense specific infrared light signals generated by flame combustion. Due to the background noise in the environment, it is necessary to fuse the data of infrared sensors of multiple wavelengths, and analyze the raw signals of multiple sensors through edge computing to determine whether there is a fire. The soil sensor, temperature sensor and wind direction sensor respectively collect surrounding environment information, including but not limited to: soil conditions, temperature and humidity conditions, wind direction and so on. The sensing device is connected to the camera through a wired connection. After judging the presence of fire, the edge side automatically sends information to the camera, so that the camera can complete the capture action and generate pictures/videos. Finally, as long as the fire results/pictures/videos are sent to the platform, the original information is not required.

The flame detection terminal and the base station are connected through a low-speed and long-distance configuration, and some terminals that cannot directly connect to the base station are connected to the base station through the adjacent terminal relay. When the terminal is powered on, it tries to directly connect to the gateway/base station. By evaluating the actual connection, the communication performance between the terminal and the gateway/base station can be evaluated. When there is no fire, the communication method with the least resource occupancy is selected. If the terminal cannot directly connect to the gateway/base station, the multi-dimensional networking mode is selected. As an example, the terminal realizes communication by means of another relayed gateway/base station terminal that can be covered, and the terminal responsible for the relay turns on the low-power monitoring mode. Monitor the preamble signal of the relayed terminal in real time. If there is no detected signal, it will enter the sleep mode immediately. If the signal is recognized, it will start to receive the entire data packet and resend the data packet to the gateway/base station.

During daily sampling, the soil sensor, temperature sensor, wind direction sensor, and flame detection terminal sample at a regular speed, and the flame detection terminal executes an algorithm locally to identify whether there is a flame. The soil sensor, temperature sensor, and wind direction sensor intermittently detect the surrounding environment. Time (such as 2 hours) to send status information including battery power, ambient temperature and humidity, flame background noise level and other information, and periodically send the raw data of some sensors as needed, these data will be transmitted to the data intelligent fusion platform through the multi-mode heterogeneous network Perform calculation to obtain the flame detection parameters under the current background noise level, and these flame detection parameters will be sent to the corresponding flame detection terminal. It should be understood that the above information is transmitted through the corresponding communication and network (dynamically provisioned by the multi-mode heterogeneous network). For example, because the above-mentioned information is short in length and infrequently sent, uncompressed or lossless compressed source coding can be used. Considering the energy consumption of the detection terminal, channel coding with higher energy efficiency (such as LDPC) is used, and low code is used. In the rate debugging mode, the transmit power of the PA is minimized to save power consumption, and the fn frequency point is randomly selected from multiple idle frequency points.

Further, the flame detection terminal samples at a regular speed, and analyzes whether there is a fire through the terminal calculation. If there is no fire, it dynamically sends the pre-judgment result, status information and other communication parameters to the server according to the detection pre-judgment result, and the interval is as needed. increase and shorten. As the risk of a fire sensed increases, the frequency of detection increases, as does the sending of relevant information. The cloud computing engine requests some raw data fragments from the device at different time periods. These raw data fragments will be used for background noise analysis. Combined with historical big data and current meteorological big data, a set of detection parameters suitable for the current detection parameter set is obtained through artificial intelligence algorithm. It is sent to the base station, and the base station sends it to the terminal one by one in a time-sharing manner. The terminal uses the detection parameter set for flame detection. The PTZ camera scans the surrounding area according to the specified cruise trajectory, and sends video data to the server in a certain period. The video data is displayed on the large screen of the monitoring center through the streaming media service and visualization engine. Multiple PTZs share the base station bandwidth in time-sharing.

When a flame detection terminal detects a flame signal, it immediately sends an alarm signal to the background, and immediately sends the data to the gateway/base station through the established communication network, and the gateway/base station sends the data to the artificial intelligence through the multi-mode heterogeneous core network. The business platform, the artificial intelligence business platform starts the emergency process according to the business needs of the industry. The artificial intelligence business platform issues control commands through the multi-mode heterogeneous core network to control the rotation of the camera near the flame detection terminal, and controls it to shoot video in the direction of the flame detection terminal, and send commands to the on-site base station through the gateway/base station through the multi-mode heterogeneous core network, the base station dynamically adjusts the communication resources to the flame detection terminal and the camera, and other devices far away from the fire area temporarily reduce the communication priority and give up communication resources. The terminal that finds the fire starts the rapid detection process, detects the flame intensity, and immediately sends it to the server through the gateway/base station. At the same time, the camera also sends real-time continuous video/pictures to the server to show the spread of the fire, providing data support for firefighters to make decisions. For example, when the sensing terminal detects changes in environmental conditions such as low ambient air humidity and rising temperature, the edge algorithm determines that the fire danger level increases, and the infrared sensor then executes the algorithm to identify whether there is a flame. The time interval becomes shorter, and the status is sent to the server. The interval of information including battery power, ambient temperature and humidity, and flame background noise level is reduced (for example, 0.5 hours). Because the above information has the characteristics of short length and relatively frequent transmission, a matching communication transmission method can be adopted: use lossless compression source coding, considering the energy consumption of the detection terminal, use channel coding with higher energy efficiency (such as LDPC), using the medium rate debugging mode, the transmit power of the PA is minimized to save power consumption, and the fn frequency point is randomly selected from multiple idle frequency points.

When the fire occurs (the flame detection terminal recognizes the flame through the algorithm), the flame detection terminal immediately sends the fire alarm information to the server, then starts the continuous flame signal sampling and executes the identification algorithm, and sends the flame intensity signal and the ambient temperature and humidity. Signals (obtained by sensors) are sent to the server, and this information will be used to assess the spread of the fire. It should be understood that the above information is also transmitted through the matching communication and network (dynamically deployed by the multi-mode heterogeneous network). For example, in order to ensure the reliability of transmission, the spread spectrum debugging method is used, and a relatively idle communication channel is selected, and the transmit power of the PA is appropriately increased to improve the signal-to-noise ratio; at the same time, the flame detection terminal turns on the camera and sends the High-definition picture data (such as jpg encoded pictures), this picture will be used for the fireworks identification algorithm (to confirm whether there is a fire), after confirming that there is a fire, the camera starts to send images and/or video information for real-time fire monitoring Depending on the actual network situation, the image and/or video information may use different definitions and use different source coding (such as H.264, H.265), at this time, use Turbo channel coding, and use Debug mode with higher bit rate (such as QAM64, QAM128), and use channels with less background noise and more idle.

In terms of emergency command, the artificial intelligence management platform obtains geographic data, vegetation data, forest fire factor data, meteorological data, real-time data of sensor terminals, fire extinguishing resources and other data from the data lake of the data intelligent fusion platform, and calculates the fire through deep learning algorithms. Point center, current fire area, fire spread trend, feasible rescue path, etc., combined with the location data of command and dispatch terminal, to deduce the optimal rescue path for on-site rescuers. Through the trajectory prediction of the command and dispatch terminal, the artificial intelligence management platform can determine the dynamic networking requirements of the command and dispatch terminal: which terminals are key terminals, the required communication rate, etc., and send the requirements to the multi-mode heterogeneous core network. The heterogeneous core network retrieves historical communication big data from the data lake, combines the on-site communication environment data, and deduces the optimal networking method and communication resource scheduling strategy through deep learning algorithms, and issues the final control commands through the gateway/base station To the command and dispatch terminal and/or the on-site mobile gateway/base station, the command and dispatch terminal forms a network according to the command and transmits various streaming media information in real time for further use by the platform. Mobile terminals and mobile base stations equipped with on-site personnel form an ad hoc network. According to on-site conditions, some mobile terminals can be identified as key terminals (such as mobile terminals worn by commanders), and priority should be given to ensuring communication speed and server quality. According to the actual communication performance on site, the interaction between terminals and between the terminals and the command and dispatch platform uses video, audio, voice messages, and text messages in turn according to the communication environment. When using video/audio communication, you can also choose to use different source encodings to achieve a balance between video/audio quality and network carrying capacity. If the network is better, use high-definition video and high-bit rate H.264 encoding, while the network is poor, use low-definition video and low-bit rate H.265+ encoding. The channel coding is selected according to the situation, for example, LDPC coding with higher energy efficiency is used for high rate, and Turbo coding with better performance is used in the case of large noise. Switch the debugging mode through the multi-mode heterogeneous network to adapt to the change of communication distance. For example, if the communication distance is very short, use QAM64, if the communication distance is slightly farther, use QAM8, and if the communication distance is very long, use FSK. Devices that need to prioritize communication quality can use dedicated communication channels.

Further, the integrated communication middle station provides three major service functions in the dispatching process: (1) Instant messaging function, which is used to issue command dispatching instructions and listen to on-site situation reports. The integrated communication middle station can establish communication between artificial intelligence business platform and field terminal, terminal and terminal, platform and multi-terminal grouping. Depending on the network connection, different communication methods can be established, typically video calls, audio calls, and text communications. Use video calls for good communication conditions, audio calls for normal communication conditions, and text communication for poor communication conditions. When it is really necessary to use a high-speed communication mode but the current terminal network connection rate is not supported, the artificial intelligence service platform can initiate a networking evaluation to the multi-mode heterogeneous core network, and the core network will evaluate and regroup through the deep learning algorithm according to the current networking status and environment. Whether the communication rate allocation of the specified terminal can be satisfied by means of network, temporary allocation, etc., and the allocation is performed if the conditions are met. When using text communication, support using the language processing unit in the algorithm center to convert the platform's voice into text and send it to the terminal; when using group calls, support video calls for some terminals and voice calls for some terminals. The artificial intelligence industry algorithm predicts and simulates the spread of fire based on current and historical data, and can directly output automatic dispatching instructions. These dispatching instructions can be directly sent to the terminal through the integrated communication center without manual participation. According to the networking situation of the terminal, Automatic scheduling instructions can be issued in voice or text format. The original format of scheduling instructions can be voice or text (of course, it can also include video, pictures or other types of files). Through the algorithm platform TTS speech synthesis algorithm and NPL natural language recognition algorithm, the scheduling instructions can be converted between voice and text. (2) Location positioning, which provides the collection and circulation of terminal location information. The algorithm middle station uses location information to generate scheduling decisions for on-site personnel, the digital twin middle station uses location information for visual display, and the multi-mode heterogeneous core network uses location information for dynamic networking and communication resource allocation. (3) On-site monitoring, the artificial intelligence business platform can actively perform operations such as pulling the terminal video stream, controlling the terminal to take pictures, and controlling the terminal recording. These operations do not require any operation from the terminal, reducing unnecessary intervention by rescuers.

According to the fire control situation, rescue personnel situation, real-time dispatch of artificial intelligence business platform and other information, the platform side calculates the communication requirements in real time and dynamically adjusts the communication strategy to ensure the real-time, dynamic and coherent communication connection of the command and dispatch terminal and on-site sensor equipment. The digital twin middle station can show to the command center: artificial intelligence industry algorithm middle station prediction simulation data (such as fire spread prediction), location data of on-site rescuers, communication network data (base station/gateway coverage area, communication equipment interconnection, etc.) to help the command and dispatch of the command center.

Of course, those of ordinary skill in the art can understand that all or part of the processes in the methods of the above embodiments can be implemented by instructing relevant hardware (such as processors, controllers, etc.) through a computer program, and the computer program can store In a non-volatile computer-readable storage medium, the computer program may include the processes of the above-mentioned method embodiments when executed. The storage medium may be a memory, a magnetic disk, a floppy disk, a flash memory, an optical memory, and the like.

It should be understood that the application of the present invention is not limited to the above examples. For those of ordinary skill in the art, improvements or transformations can be made according to the above descriptions. All these improvements and transformations should belong to the protection scope of the appended claims of the present invention.

Referring to FIG. 2, the present invention provides an example of the composition of the next-generation Internet of Things.

The next-generation Internet of Things is characterized by weakening the boundaries of sense (sensor), transmission (communication), calculation (computing), control (control), and use (application) of the traditional Internet of Things, and enhances the interaction between various layers. The operability is guided by dynamic, on-demand and rational allocation of resources, so that the layers can promote each other, so that the system can achieve the overall optimization.

From the perspective of sensor layer, sensor terminals can perceive or collect data from objects and people. For example, the sensing terminal can collect environmental data of the surrounding environment (such as temperature, carbon dioxide concentration, atmospheric pressure, etc.), as well as data such as images and sounds of human activities. By adding a terminal computing function to the sensor layer, for example, by adding a processor to the sensor terminal, the sensor terminal can be equipped with data processing capabilities, so that the sensor terminal can directly analyze the collected data after collecting the data, and generate decision-making As a result, local decisions can be made even at the edge side of the sensing terminal. It should be noted that the edge side is not a single component nor a single layer, but an end-to-end open platform involving EC-IaaS, EC-PaaS and/or EC-SaaS. Typical edge computing nodes generally involve networks, virtualized resources, RTOS, data plane, control plane, management plane, or industry applications, etc. Among them, network, virtualized resources, RTOS, etc. belong to EC-IaaS capabilities. Data plane, control plane, management plane, etc. Surfaces, etc. belong to the EC-PaaS capability, and industry applications belong to the EC-SaaS category.

In some embodiments, one sensing terminal can establish a communication connection with multiple other sensing terminals, and multiple sensing terminals can transmit collected data to each other, so that any sensing terminal can combine multiple or multiple sensing terminals. Sensing data for comprehensive decision-making can realize more complex and higher-level decision-making by integrating data collected by multiple sensing devices, making the decision-making result more accurate. The combination of FIG. 4 and FIG. 5 is the flow and principle of communication between terminals. For example, the sensing terminal can receive the temperature data sent by the temperature sensor, the carbon dioxide data sent by the carbon dioxide sensor, the humidity data sent by the humidity sensor, etc. to comprehensively determine whether a fire is currently occurring. Compared with making decisions based on only one type of perceptual data, combining multiple perceptual data to make decisions, changing the basis from a small amount of “sample data” to a massive “overall data”, a more comprehensive, multi-dimensional fusion and visualization can be obtained. Decision-making results, so as to avoid false alarms and waste of rescue resources.

In some embodiments, the sensing terminal can be directly connected with the execution terminal through the dynamic communication between things in the multi-mode heterogeneous network, so that after the sensing terminal makes a decision based on the sensing data, if a specified condition is reached, the execution terminal needs to be executed. To execute a corresponding action, the sensing terminal can directly send a control instruction to the execution terminal to instruct/link the execution terminal to execute the corresponding action. FIG. 4 is a flow of a sensing terminal sending a control instruction to an executing terminal. For example, when the sensing terminal makes a decision that there is a fire, it can send action instructions to the alarm and sprinkler mechanism to instruct the alarm device to issue an alarm prompt and instruct the sprinkler mechanism to start sprinkling water. By making decisions directly by the sensing terminal and sending control commands directly to the executing terminal, there is no need to wait for the upper-level equipment such as gateways or servers to analyze the sensing data and make decisions, which can save decision-making time. It can analyze the data by itself and then generate control commands to start the execution, so as to win more rescue time when a dangerous situation occurs.

In a further preferred embodiment, after the sensing terminal makes a decision according to the sensing data, the sensing strategy, communication parameters and/or network transmission rules of the sensing terminal can be adjusted according to the content of the decision. Exemplarily, when the decision content display reaches a specified condition, such as when a dangerous situation occurs, the sensing terminal can automatically adjust the sensing strategy, such as increasing the sampling frequency, increasing the sampling progress, etc., and can request the upper-level device to change the communication parameters and strategies. Therefore, higher speed, higher reliability and more suitable transmission can be obtained in the form of multi-mode communication. The dynamically adjustable communication parameters include carrier frequency, carrier bandwidth, modulation method, channel coding, transmit power, and receive sensitivity.

From the perspective of the communication layer, multi-mode heterogeneous networks can provide diverse, configurable, and coordinated network connections for sensing terminals, and can dynamically and on-demand provide terminals with suitable network communication resources. For example, after the sensing terminal makes a decision, it can also send the collected data and the decision result to the upper-level device (such as a gateway) at the same time, so that the upper-level device can store and analyze all the data collected by the sensing terminal. Exemplarily, the sensing terminal can establish a communication connection with the gateway, the sensing terminal can send the collected data and decision results to the gateway, and the gateway itself can have data processing capabilities, so the gateway can The processing result generates a decision result on the gateway side, that is, fog computing is implemented on the gateway side. The fog computing refers to that the data from sensors and edge devices is not all stored in the cloud data center, but a layer of “fog” is added between the terminal device and the cloud data center, that is, the network edge layer, which combines data, Data processing and applications are centralized in the device gateway at the edge of the network, and the cloud server stores data synchronously. For larger data fog devices (gateways), they can be processed locally, extract meaningful features, and then synchronize to the cloud. This way It can greatly reduce the computing and storage pressure in the cloud, with lower latency and higher transmission rate. The terminal device and the fog device (gateway) are transmitted in a multi-mode heterogeneous network, which can greatly ensure the smooth communication in various situations. Exemplarily, the gateway can process data of all terminals under its coverage, and its decision effectiveness tends to be more global, so the accuracy of the decision result made by the gateway can be greater than the accuracy of the decision result made by the sensing terminal. When the decision result made by the gateway side is inconsistent with the decision result made by the sensing terminal, the gateway can send an adjustment command to the sensing terminal to adjust the sampling behavior of the sensing terminal and can send a control command to the execution terminal to adjust the action of the execution terminal. Realize the network synergy and realize the optimization of the control. For example, parameters such as the sampling interval of the sensing terminal and the size of the preset threshold can be adjusted, and the execution terminal can be adjusted to terminate the execution action. For example, in a building fire protection application, once a gateway receives the alarm information of the smoke sensor, it will send the alarm information to the nearby gateway, and finally the whole building gateway can receive the alarm information, and the whole building gateway will connect to it. The smoke alarm of the whole building will send an alarm command, and finally the smoke alarm of the whole building will give an alarm at the same time, warning all the people in the whole building to evacuate quickly. Through the gateway communication technology, the fire alarm information is guaranteed to be broadcast to the entire building in the first time, and the broadcast of the alarm information will not be affected in the event of an abnormal communication between the gateway and the cloud.

In a further preferred embodiment, the gateway can also directly send a control instruction to the execution terminal according to the decision result made to instruct the execution terminal to perform corresponding actions, and can adjust itself and adjacent gateways, base stations and/or sensor The communication parameters of the device, so that higher-quality communication services can be provided for high-priority devices. For example, according to the data characteristics of the IoT terminal, services can be divided into delay-sensitive services (such as data uploaded by fire alarm sensors), large-bandwidth requirements services (such as live broadcast, monitoring data), and ordinary services (such as temperature and humidity sensor uploads) The data). Different types of services have different requirements on channel delay and bandwidth. Multi-mode sites allocate appropriate channels for IoT terminals according to their service types to ensure efficient data transmission. In the embodiment of the present invention, the gateway holds other gateway secret keys, uses TLS for connections between gateways interconnected through IP, uses token authentication for subordinate gateways, uses TLS for connections between gateways interconnected through IP, and uses X.509 authentication The right, through the IP interconnected gateway connection, uses the digest algorithm for authentication and two-way authentication; uses the LoRa connection terminal, uses the private protocol, DH key exchange. Gateway and inter-gateway and cloud communication technology. It supports automatic networking, automatic scanning, and automatic connection of the intranet; the gateway supports LoRa, and the slave gateway can scan at the specified frequency point and connect automatically.

From the perspective of the computing layer, by introducing the cloud-side co-computing framework, the tasks of coordinating end computing (sensor terminal), fog computing (gateway) and cloud computing (cloud server) are effectively allocated, and communication and network transmission are controlled to adapt to the Changes in transmission requirements brought about; on the contrary, when the network state changes, the cloud-side co-computing framework can also dynamically adjust the computing strategy to provide better communication services. In this embodiment, side-cloud collaboration (also called cloud-side collaboration) involves comprehensive collaboration at all levels of IaaS, PaaS, and SaaS. EC-IaaS and cloud-based IaaS should be able to achieve resource coordination for networks, virtualized resources, security, etc.; EC-PaaS and cloud-based PaaS should be able to achieve data collaboration, intelligent collaboration, application management collaboration, and business management collaboration; EC-SaaS and cloud SaaS should enable service collaboration.

In some embodiments, the gateway can establish a communication connection with the server, and can send the data sent by the sensing terminal, the decision result made by itself, and the decision result of the sensing terminal to the server, so that the server can comprehensively process all the sensing data. and/or deep learning and make decisions. Since the computing power of the server is often greater than that of the gateway and the terminal, and the server can process the data of all gateways and terminals under its coverage, the accuracy of the decision result made by the server is usually greater than that of the gateway and the terminal. Accuracy. In practice, due to the imbalance and instability of the network, not all terminals can provide the accurate data required by the algorithm. The multi-mode heterogeneous network ensures the transmission of key data according to the algorithm requirements to ensure the normal operation of the algorithm, so as to realize the network protocol. Calculate. Exemplary, but when an abnormal situation occurs, when the algorithm running in the algorithm center has special requirements for the input data, such as when a certain device needs to send higher-definition pictures, and a certain area-aware terminal sends more densely sampled data, the algorithm center can send the data. The multi-mode heterogeneous core network sends a control request, and the core network coordinates the network resources through the base station/gateway to meet the algorithm's requirements for the terminal to transmit data, so as to realize the calculation control network; when the actual communication capability of the terminal cannot fully meet the data requirements of the algorithm, it can be Allocate some computing tasks to the base station/gateway and terminal side, and realize cloud-side co-calculation through reasonable computing power balance, task dispersion, algorithm complementarity and communication status. Exemplarily, when adjusting the computing capability of the gateway, it may be adjusting the communication parameters of the gateway, adjusting the number of access terminals of the gateway, adjusting the computing cycle of the gateway, etc.; when adjusting the computing capability of the sensing terminal, it may be adjusting the Communication parameters, adjusting the sampling interval of the sensing terminal, adjusting the coverage area of the sensing terminal, adjusting the computing cycle of the sensing terminal, etc. The communication parameters may include carrier frequency, carrier bandwidth, modulation mode, channel coding, transmit power, receive sensitivity, and the like.

In some embodiments, after the server makes a decision result, the server may directly instruct the execution terminal to execute a corresponding action, thereby realizing direct control of the execution terminal by the server. Since the server has a high-level decision-making capability, when the execution command sent by the sensing terminal received by the execution terminal is inconsistent with the execution command sent by the server, the execution terminal can only execute the corresponding action according to the execution command sent by the server. And because the server has a higher-level decision-making ability, the server can directly control the action of the actuator, which can also provide better communication services for high-priority devices.

From the perspective of the control layer, in the process of communication between the sensing terminal, gateway, server, and execution terminal, it is possible to achieve and ensure faster and more reliable delivery of control commands, command scheduling and related information through dynamically allocated communication and networks. execution of the operation. For example, the sensing terminal itself can dynamically adjust its sampling interval, sampling time, sleep time, etc., and can also request the superior device to allocate more communication resources to provide better communication services when the set conditions are met; the gateway can adjust It can also adjust the communication parameters of its own communication parameters, and the communication parameters of the sensing terminals connected to it; the server can adjust the communication parameters of all the terminals it covers, and can dynamically adjust the task ratio, time domain allocation, compensation rate, etc.

From the perspective of the application layer, sensor terminals, gateways, computing frameworks, multi-mode heterogeneous networks, etc. have become explicit resources, and all resources can be dynamically allocated and coordinated as needed. The terminal assigns different tasks and/or sets different priorities for the sensing terminal, and allocates more communication resources to the sensing terminal with heavier tasks or higher priority, so as to improve the data collection, data calculation, and data transmission of the sensing terminal and other data processing capabilities, to achieve a sense of demand control, so as to provide users with better communication services. Similarly, different communication resources or different tasks can also be allocated to the gateway according to user requirements, so as to control the network according to the needs and improve the computing capability and computing efficiency of the gateway. Similarly, the server can also be instructed to adjust the communication resources of the lower-level devices connected to the server according to user requirements, so as to achieve the purpose of rationally allocating the communication resources. According to user requirements, the execution actions of the execution terminal can also be adjusted, so as to realize the decision/scheduling of the execution terminal according to the user needs. For example, the execution action of the execution terminal can be increased/decreased, the execution force of the execution terminal may be increased/decreased, and the like according to user requirements.

In some embodiments, the application data collected and processed by the cloud server can also be fed back to the user layer, so that the user layer can monitor and make decisions on the data. In addition, the server can also establish a data model that matches the user's needs according to the collected and processed data and different user needs. According to these data models, the user layer can more easily and quickly understand the operation of each terminal within the scope of the Internet of Things. And the situation of the data collected by each terminal, so as to realize the feedback on the user's needs.

In some other embodiments, the next-generation physical network may further include a security system, an operation and maintenance system, and a management system.

Among them, the security system can provide security support for the data collection, data transmission, data processing and other steps of each terminal/device in the Internet of Things, and can solve any data security-related problems such as illegal intrusion, data leakage, and external attacks; The security system starts with multi-mode heterogeneous network security, and dynamically controls security from the root, rather than only ensuring security at the platform layer. The security management platform provided by the present invention interacts with the terminal layer (including various sensors, etc.), the communication layer (including base stations, gateways, etc.), and the support layer (including data center, core network, etc.) of the multi-mode heterogeneous system, thereby Dynamic and linkage control of the entire multi-mode heterogeneous system to ensure data security and communication security. The security management platform provided by an embodiment of the present invention is suitable for any scenario where IoT devices are securely connected to the cloud; it is suitable for securely connecting with any type of third-party platform data, providing secure channels and data tamper-proof functions; It can be used in combination with various communication types, that is, to meet the needs of multi-mode heterogeneous networks; it is suitable for scenarios where IoT device data, user-generated data, third-party access data are securely accessed and data is uploaded to the blockchain for protection. In this embodiment, the security management platform is divided into three components, namely security resources, security services, and security management. Among them, the security resource component includes a password resource pool, a key management system, a signature verification system, and a data encryption and decryption system. Configure the cryptographic resource pool in advance, and then establish a key management system, a signature verification system, and a data encryption and decryption system based on the cryptographic resources and encryption/decryption algorithm resources of the cryptographic resource pool. The security management component includes systems such as communication security, network security, data security, situational awareness, emergency response, knowledge graph, and user management. Among them, communication security, network security, and data security provide situational awareness with sensor data of security situation; situational awareness analyzes security situation; situational awareness provides results to emergency response, and emergency response notifies relevant security personnel; then the entire security incident is reported. Store in the knowledge graph for storage and record; the knowledge graph provides the basis for the configuration of communication security, network security, and data security, forming a closed loop. Security service components include lightweight authentication services, security authentication services, and blockchain services. The security service component is based on the security resource component, and under the call management of the security management component, provides security services to the business system and the Internet of Things terminal. To solve the problem of device key distribution and storage difficulties.

The operation and maintenance system can realize the unified operation and maintenance of each terminal/device in the Internet of Things. For example, tasks such as intelligent inspection, alarm dispatch, work order dispatch, work order disposal, and log management can be arranged through the operation and maintenance system; It provides support for the dynamic allocation of communication resources, and can achieve unified management of physical devices and physical environments in the Internet of Things, including unified resource management of computing resources, storage resources, network resources, security resources, and monitoring and sensing resources. The cloud management platform can uniformly manage resources such as memory, hard disk, input/output interface, CPU and/or GPU in the cloud. It can also dynamically expand and manage the computing resources of any interface: it can directly connect the computing resources of physical devices to virtualize them into computing resources, and it can also connect to the virtualization platform to indirectly manage and connect the computing resources of physical devices.

Referring to FIG. 3, the present invention provides an example of a next-generation IoT global relationship.

The present invention provides an Internet of Things platform, which includes: a terminal layer, a communication layer, a support layer and an application layer arranged in order from bottom to top.

In the terminal layer, the terminal, as a node of the communication network, participates in the establishment of the network, obtains network status information, determines the sensor and execution strategy according to the network status information, and adjusts the sampling mode according to the business needs and the communication environment to obtain the sensor data. Including: sampling frequency, sampling precision, source coding and/or compression method. As an example, the air quality monitoring station used for dust monitoring on construction sites uses a wireless gateway to send back data, in which particulate matter sensors are used to evaluate the dust situation, and high-frequency sampling data can obtain a finer dust change curve, but if the system deploys more There are different types of terminals, and the capacity of the gateway is limited, then the frequency of sampling and backhaul can be appropriately reduced to reduce the occupation of communication resources. When there is a construction site during the day, a slightly higher sampling frequency should be used. If the wind speed is high and the dust dispersion changes rapidly, a higher sampling frequency should be used to adapt to accurate change tracking. If the construction site is not constructed at night, the sampling frequency, sampling accuracy and return frequency can be reduced. If the dust change is small, the source coding can be changed to the difference method, that is, the difference from the previous value can be represented by fewer data bits. It is also possible to accumulate multiple sampled data and compress it using a compression algorithm and send it uniformly.

In the communication layer, base stations and gateways introduce fog computing, perform fog computing based on the sensor data of all terminals under their coverage, and adjust terminal communication resources; as an example, in the monitoring system of a smart greenhouse, one gateway is responsible for Data transmission and computing services, where each type of terminal is installed at multiple points as needed. Among them, the light terminal is used to evaluate the light level in the greenhouse. The light in the daytime is relatively strong, and more attention should be paid to the change of humidity in the greenhouse, while the temperature change is relatively unimportant. At night, the illumination is low, and more attention should be paid to temperature changes to prevent frostbite of plants, and the amount of evaporation at night is small, so humidity does not need to be paid special attention. The gateway continuously collects the sensor data of the terminal and analyzes the illumination data through fog computing. If the illumination data exceeds a certain percentage and exceeds the set threshold and lasts for a certain period of time, it can be determined that it is daytime, and the gateway sends a communication resource adjustment command to the terminal, which notifies the temperature The detection terminal reduces the occupation of communication resources, and the humidity detection terminal increases or decreases the occupation of communication resources.

In the support layer, the artificial intelligence algorithm cloud computing platform sends commands to the multi-mode heterogeneous core network to change the communication and networking performance of different terminals, use different algorithm parameters and allocate different algorithm resources according to the sensor data; as an example, An urban management project deploys multiple cameras, which are covered by multiple multi-mode heterogeneous base stations, and the support layer deploys deep learning algorithms for road occupancy business identification and fireworks identification. The project is deployed in Jurisdiction 1 and Area 2. Area 1 focuses on firefighting and road occupation operations. Road occupation operations require attention during the day, but not at night, while fire protection requires all-day attention and nighttime attention. Among them, Area 2 only focuses on fire protection during the day. The AI algorithm platform mobilizes resources according to this demand. At the beginning of the day, a command is sent to the multi-mode heterogeneous core network to increase the communication authority of the occupancy camera in area 1, and at the same time allocate more computing resources to it. The occupancy camera is used to collect and send high-definition video data. Adapt to the identification of high-definition video data; the communication authority of the fireworks identification camera in area 1 is reduced, the camera only collects low-resolution images and transmits them at low frequencies. The algorithm platform only provides some computing resources, and rough identification can be done by adjusting the algorithm parameters; the algorithm platform Increase the communication authority of the fireworks recognition camera in Area 2, allocate more computing resources to it, and adjust the computing parameters to improve the recognition speed and recognition rate. Before the night starts, the algorithm platform allocates the communication resources of the road-occupying cameras in Area 1 to the pyrotechnic recognition cameras, and only retains basic connection communication. rate algorithm parameters; the pyrotechnic recognition camera in area 2 has sufficient bandwidth, and still keeps communication resources occupied. The camera still sends high-definition images, but the algorithm resources are partially released, and the algorithm parameters used can ensure the general recognition rate. The multi-mode heterogeneous network coverage area extends from the communication layer down to the terminal layer, and up to the support layer and application layer; the cloud-edge co-computing framework coordinates the task allocation of cloud computing, fog computing and edge computing.

In the application layer, the visualization engine is used for visual display. The operation and maintenance management platform and cloud management platform provide unified resource services and unified operation and maintenance services. The blockchain security management platform provides unified security management services, and security management covers the sensor layer, communication layer, support layer until the top application layer.

In some embodiments, in the terminal layer, the terminal may participate in forming a network as a node of the communication network, and the terminal may obtain network status information, and then change the sensor or execution strategy. The terminal performs edge computing and adjusts parameters such as sampling frequency, sampling accuracy, source coding, and compression method according to business needs and in combination with the communication environment. The terminal layer adds the edge computing function, and the sensing data can make local decisions on the edge side, so as to directly link the execution terminal; due to the existence of edge computing, it can realize more complex and high-level decision-making by integrating the data of multiple sensing devices; the results of edge computing The importance and urgency of the corresponding sensor data can be improved, and the terminal can obtain higher-speed, more reliable and more suitable communication and network resources through dynamic adjustment of communication parameters and network transmission rules. When there is a big change in the sensor data and need continuous attention, you can apply for more network resources to the communication layer and the support layer as needed through data transmission, while increasing the sampling frequency and accuracy, and the multi-mode heterogeneous network dynamically adjusts through communication to achieve resource allocation. Dynamically adjustable factors include carrier frequency, carrier bandwidth, modulation method, channel coding, transmit power, and receive sensitivity. As an example, in an urban fire protection application, multiple smoke sensor terminals are installed on each floor of a building, and the terminals have temperature identification capabilities and use one or more wireless gateways to communicate. During normal operation, all terminals have been detected at a certain frequency, but data is sent to the gateway only once a few hours to report the device status (such as battery power, temperature, etc.). Low transmit power and medium receive sensitivity. When a fire occurs on a certain layer, all terminals on this layer will send smoke concentration and temperature data at a faster frequency. These data are used by the algorithm to calculate the fire spread and calculate the best escape route, in order to cope with the temporary increase in communication resources. It is necessary to enable multi-carrier frequency points for communication between the gateway and the device, use the GFSK debugging method that supports higher rates, and improve the transmit power and receive sensitivity to ensure the communication distance.

In some embodiments, in the communication layer, the multi-mode heterogeneous network provides diversified, configurable, and coordinated network connections, and can dynamically and on-demand provide terminals with appropriate network communication resources; gateways and base stations introduce fog. Computing function, fog computing can be based on the data of all terminals under its coverage, and its decision-making effectiveness tends to be more global. The multi-mode heterogeneous network coverage area extends from the communication layer down to the terminal layer, and up to the support layer and application layer.

In some embodiments, in the support layer, a variety of services and algorithms such as big data fusion, converged communication services, streaming media services are provided, and artificial intelligence algorithms can control multi-mode heterogeneous core Cloud computing provides algorithm support. Artificial intelligence algorithms have different requirements for terminal sensor data in different time periods and different locations, such as sampling rate, accuracy, code stream, etc. The artificial intelligence algorithm platform can send commands to the multi-mode heterogeneous core network to change the communication of different devices. and networking performance, and then use different algorithm parameters and allocate different algorithm resources according to the actual sensor data. Typical example: cameras monitoring random hawking during the day need to capture images frequently, while cameras used for boundary detection late at night have higher priority; forest fire factor terminals used in forest fire prevention can be reduced in low temperature or rainy weather. The collection frequency of combustible layer and meteorological sensing data, and when the weather is dry and high temperature, the sampling frequency is increased to obtain a faster response time.

In some embodiments, at the application layer, an artificial intelligence service platform is provided, and through CIM, BIM, GIS, AR, VR and other visualization engines, the data provided by the support layer, sensor and control terminals, computing frameworks, multi-mode Heterogeneous networks, etc. have become explicit resources in a visual way, and all resources can be dynamically allocated and coordinated as needed, which can realize various and various lines from operation to management to service, from monitoring to plan, from decision-making to scheduling, etc. Business jobs in various industries. In the event of an accident, some terminals (such as emergency terminals, terminals for rescue vehicles, and related terminals at the accident site) require more network resources, and the application side can directly issue commands to the multi-mode heterogeneous core network.

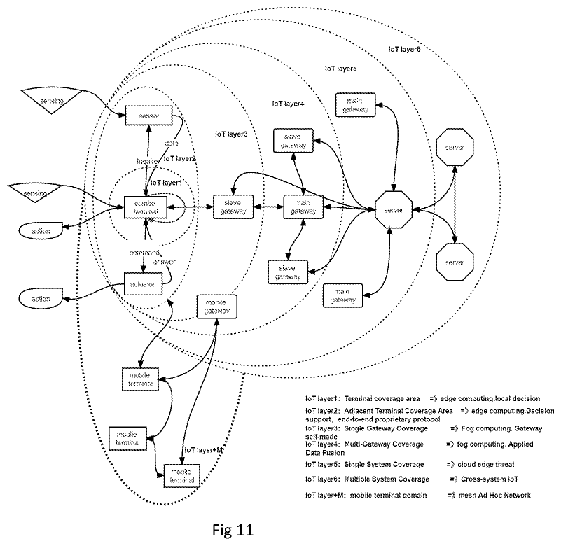

In some embodiments, by introducing a cloud-edge co-computing framework, the task of coordinating edge computing, fog computing and cloud computing is effectively allocated, and communication and network transmission are controlled to adapt to the resulting changes in transmission requirements; conversely, when the network When the state changes, the cloud-edge co-computing framework can also dynamically adjust the computing strategy. The cloud-edge co-computing framework coordinates the task allocation of cloud computing, fog computing and edge computing, and realizes the cloud-edge computing co-slave. The cloud-edge co-computing framework allocates tasks according to the demand definition of the business platform, the communication big data of the multi-mode heterogeneous network, and the communication and computing capabilities of the gateway and terminal. FIG. 11 shows the edge computing decision-making ring structure. Typical example: vision-based fire protection systems, on-site image sensor devices and the cloud have fireworks recognition capabilities based on deep learning. The sensor devices use uncompressed image data, which is more friendly to the algorithm, because only the recognition results need to be transmitted and no transmission is required. When the image is sent to the cloud, the communication requirements are also low, but the limited computing power of the sensing terminal still limits the recognition ability of the algorithm; the corresponding cloud computing uses the compressed image sent back by the sensing terminal through the network. The network transmission requirements are higher, but the computing power of the cloud is relatively abundant. A reasonable combination of the advantages of edge computing and cloud computing can effectively improve the recognition rate and reduce the false alarm rate. Therefore, it is necessary to dynamically adjust the task ratio, time domain allocation, and mutual compensation rate of cloud edge computing to a reasonable range. The dynamic communication adjustment feature provides the necessary support for the dynamic communication requirements brought about by cloud-edge computing coordination and slave adjustment. In order to take into account the needs of self-made network disconnection in some scenarios, the gateway and the terminal can have two different task groups, one set is used when the network is unblocked, and the other is used when the network is disconnected. It can also generate decisions independently, avoiding decision failure and decision delay caused by disconnection and weak network. When the network is smooth, we hand over the authority to the gateway or the upper-layer server. It should be understood that there can be multiple sets of different task groups, and even we can say that we can have weak network, disconnected network and smooth network. We can divide it into more situations. In each case, we should use different task group strategies. Then let the gateway and the terminal take their respective responsibilities. In the embodiment of the present invention, the devices at the terminal layer are connected to the multi-mode heterogeneous IoT sensor platform, and the multi-mode heterogeneous IoT sensor platform manages the devices at the terminal layer and the communication layer, and provides services according to industry requirements or/and physical locations. Multi-mode heterogeneous network services and edge computing services that dynamically adjust any communication parameters. Ad Hoc communication uses negotiation channels and data channels. The negotiation channel is used for device network access, status publishing, and communication negotiation; the data channel is divided into broadcast channel and directional channel. The broadcast channel is used to send multicast and broadcast data, and the directional channel is used for node-to-node communication; for the same transceiver. The network access process uses the network access request and network access response methods. The network entry response contains the interconnection status between the devices (whether communication is possible, link status). A device that has already joined the network or is about to join the network can send the network connection response in multiple windows according to the distance from the networked device (using the received signal strength). The number of windows and the distance range corresponding to each window are defined according to actual needs; Adopt random delay and detect channel occupancy before transmission with less collision. When the negotiated channel is used for communication between nodes, the communication rate and transmission power are determined according to the actual radio frequency situation; when the data needs to be routed by intermediate nodes, the communication between nodes and routes, and between routes and routes can use different channels and rates according to the actual radio frequency environment, function and other parameters.

In some embodiments, the operation and maintenance management platform and the cloud management platform provide unified resource services and unified operation and maintenance services, covering the sensor layer, the communication layer, the support layer and the top application layer, serving all layers of the entire system. The operation and maintenance management platform and the cloud management platform are for unified management of physical equipment and physical environment, including unified resource management of computing resources, storage resources, network resources, security resources, and monitoring and sensor resources of the cloud room. Typically, the cloud management platform dynamically adjusts the computing resources to the corresponding algorithms and adjusts the network resources to the related devices when the algorithm's requirements for computing resources and network resources change at different time periods. The computing resources can also be adjusted according to the needs of the corresponding algorithms such as the data type, compression ratio, code rate supported by the application and communication bandwidth. High compression ratio data sources require less memory, but require more computing power to achieve suitable computational precision. For example, in the aspect of emergency command and dispatch for forest fire prevention, the command and dispatch terminal is wirelessly connected to the cloud management platform through a wireless communication module. The cloud management platform based on the multi-mode heterogeneous network will be based on the forest fire spread area and spread time predicted by the artificial intelligence management platform, according to the distance from the command and dispatch terminal to the fire scene, combined with whether the command and dispatch terminal will be in the area where the fire will spread in the short term, etc. In emergency situations, dynamically adjust bandwidth and rate, and prioritize information communication at key space points and/or key time points, such as the communication quality of command and dispatch terminals that may be in a dangerous state. Among them, the communication connection between the command and dispatch terminal and the cloud management platform can adopt LoRa, NB-IoT or multi-mode heterogeneous communication. Therefore, when multi-mode heterogeneous communication is used in the emergency command and dispatch of forest fire prevention based on the Internet of Things, it not only realizes wireless communication, but also effectively reduces costs.

In some embodiments, the blockchain security management platform provides unified security management services, and security management runs through all horizontal and vertical levels (sensor layer, communication layer, support layer to the top application layer), providing a full-chain, end-to-end Unified Security Services. The blockchain security management platform uses the information of the transmission process to encrypt the transmitted data. The information of the transmission process can include: node location (such as latitude and longitude coordinate data), communication standard, time point, communication serial number, communication path, frequency, bandwidth, and/or speed, etc. The information used for encryption can also be various indicators/characteristics of the communication endpoint or various combinations of the above transmission information and the characteristics of the communication endpoint. In the present invention, the blockchain security management platform utilizes the chain of ready-made gateways, and utilizes the location of the gateway (such as latitude and longitude coordinate data, with the latitude and longitude information of the gateway during data transmission), communication protocol information and time information for data encryption. The receiver verifies the authenticity of the data by checking the location information, communication protocol information and time information. The path (the path is defined by the geographic location information of the gateway through which the data passes) is converted into a key for encryption, and the receiver determines whether the data is legitimate by checking the path information. The recipient needs to know or collect the legal route in advance, or the location information of the legal route point (eg gateway). It should be understood that the data transmission path is different, the decryption key is different, the next node knows the location information of the previous node, layer by layer encryption, layer by layer decryption: the next node decrypts the previous node, and then transmits it to the next node after decryption. Alternatively, the decryption may not be performed in the node transmission, and the layers are encrypted and transmitted to the server or the cloud, and the server or the cloud will decrypt. The method of using the key solves the problem of difficulty in key distribution and storage for terminal equipment, intermediate nodes (such as terminals, relays, routers, etc., which are network nodes), and gateways/base stations. At the same time, the encryption process ensures data security from the source of the terminal data, runs through the multi-mode heterogeneous core network of the network layer/communication layer and the support layer, and provides secure data transmission for other sections of the support layer and application layer, rather than only on the platform. layer to ensure security.

For example, the first sensing terminal at the terminal layer needs to transmit Data1 data to the first server, and the first sensing terminal has a unique device ID1, HMAC1 key, and public-private key pair {NPkey1, NSkey1}; the first server Have a public and private key pair {CPkey, CSkeya}. The first sensing terminal has a real-time clock and latitude and longitude position data, and sends data Data1 to the first server at time T1 and location L1. The encryption process includes: \textcircled{1} encrypting T1 and Data1 with the server public key CPkey to obtain the ciphertext E1; \textcircled{2} using the private key NSkey1 to digitally sign ID1 and E1 to obtain the signature S1; \textcircled{3} using the HMAC1 key to perform a hash operation on E1 and S1 Obtain the hash value H1; \textcircled{4} Send the data ID1, E1, S1 and H1 to the first server for decryption by the first server. It should be understood that the encryption can also be generated at the sensor terminal or gateway, as required.

In some embodiments, each node in the transmission can perform a superimposed digest algorithm on the data. After the server receives the data packet, the server performs a digest algorithm on the information of the sending node and intermediate nodes one by one to ensure the integrity and authenticity of the data. In connection with the above example, in step 4, it also includes: the first sensing terminal sends data ID1, E1, S1 and H1 to the first server and passes through several communication nodes in turn, wherein the communication nodes can be gateways, base stations, communication nodes. Continuing and other devices involved in communication. Each node performs an overlay digest algorithm for the data sent by the previous node: after node m receives the data IDn, En, Sn and Hn sent by node n, it obtains the real-time time Tm and location Lm. Then, the hash value Hm is obtained through the digest algorithm. Finally, the data IDm, IDn, En, Sn and Hm are sent to the next communication node, and so on, and finally the data is sent to the server. The encryption method provided by the embodiment of the present invention ensures the confidentiality, integrity and availability of data, and can resist common communication attack methods. For example, the saboteur obtains data packets by monitoring the communication. Since the data is encrypted at the source of the sensing terminal, the saboteur cannot easily obtain the original data, so it cannot know the content of the data, thus ensuring the confidentiality of the data; When the packet passes through each node, the integrity check value will be recalculated. The receiver will recalculate the integrity check value in the same way. Only when the data sender and all intermediate nodes are correct can they pass. This operation not only ensures the integrity of the data The security also ensures the non-repudiation of the communication node; the saboteur intercepts the data packet and resends the same data packet to the intermediate node (ie, replay attack). Integrity check and decryption will fail and the data packet will be discarded; if the saboteur uses the man-in-the-middle attack method to simulate itself as an intermediate node, since superposition encryption and verification cannot be performed, any changes to the data cannot pass through the receiving end verification.

The blockchain security management platform removes the trouble of key distribution and storage and saves resources; at the same time, it expands the communication security dependence from node to node to the communication chain, with high security and high reliability functions, greatly improving the Internet of Things. security of the entire system. The blockchain security management platform provided by the present invention is suitable for any scenario where IoT devices are securely connected to the cloud; it is suitable for securely docking any type of third-party platform data, providing a secure channel and data tamper resistance; it is suitable for and Combination of multiple communication types, such as LoRa, NB-IoT, LTE, Bluetooth, Zigbee, Sub 1G, WLAN, 4G, 5G, etc.; suitable for IoT device data, user-generated data, third-party access data Scenarios for secure access and uploading data to the blockchain for protection.

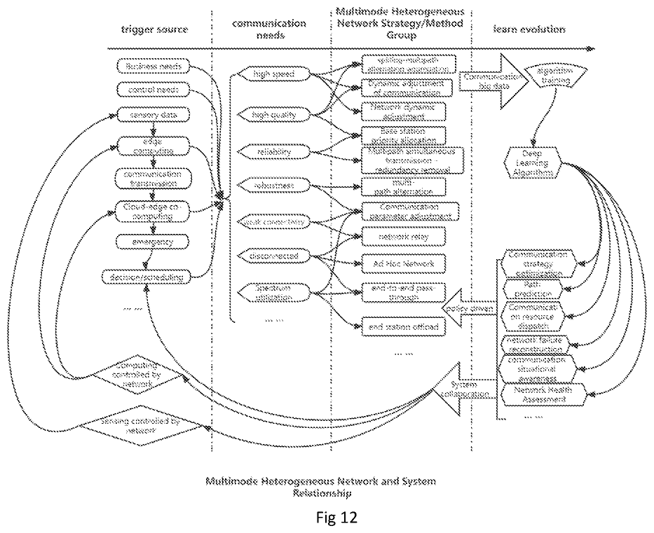

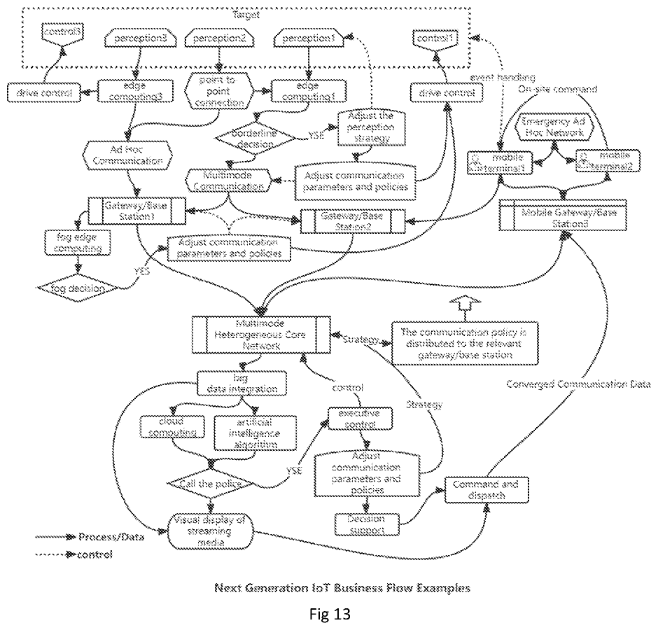

Referring to FIG. 12, the present invention provides an example of a multi-mode heterogeneous network process and system relationship.

The present invention provides a method for dynamic adjustment of a multi-mode heterogeneous network. The method includes: acquiring a communication trigger source of a terminal; determining a communication requirement according to the communication trigger source of the terminal; and providing a corresponding communication strategy according to the communication requirement.

In the field of Industrial Internet, the three elements of communication are: ubiquity, dynamic and real-time. Among them, ubiquity mainly refers to the widespread and ubiquitous network. It is impossible for the operator network to achieve ubiquity based on its profit-making nature, while the multi-mode heterogeneous IoT can be built according to the location and demand, that is, in the required location. Set up corresponding multi-mode heterogeneous base stations. For example, in the Daxing'an Mountains, the coverage of operator networks in forest areas is almost non-existent, and it is impossible to achieve large-scale deployment of operator networks. However, by deploying multi-mode heterogeneous base stations to cover the target According to business needs, communication needs and low-cost needs, a single base station needs a large coverage area (corresponding to longer communication distances), and the base station group only provides a limited overall bandwidth. Second, dynamic means that the network is dynamically variable. Dynamically adjust any communication parameters to establish a network according to industry requirements or/and physical location. In addition to mainstream communication modes, it also includes advanced networking methods such as Mesh, relay, and SDN. Finally, real-time refers to the delay of communication. Real-time is relative. In different communication scenarios, the real-time delay is not the same. In order to meet the above three situations, the concept of multi-mode heterogeneity is proposed. As shown in FIG. 1, B is dynamically determined according to A. Among them, A includes three situations: (1) the needs of the industrial industry (2) the environment in which the terminal, gateway, and base station are located (such as: time, location, task, channel, etc.) (3) the conditions of the terminal, gateway, and base station itself (such as: energy, noise, interference, etc.). B further includes data, communications, networks, and the like. Specifically, in the first case, the demand of the industrial industry means that different industries have different requirements for communication. For example, the environmental protection industry has the needs of the environmental protection industry, the safety supervision industry has the needs of the safety supervision industry, and the water conservancy industry has the needs of the water conservancy industry. Their needs are different. In the second case, the environment where the terminal, gateway, and base station are located refers to the physical environment, that is, the physical environment where the terminal, gateway, and base station are located, which further includes time, place, task, and channel. In the last case, the conditions of the terminal, gateway, and base station include its own power, sensor value, sensor conversion rate, and parameters such as communication interval, transmission power, and modulation mode are dynamically adjusted. A dynamically determines B. Typically, parameters such as communication interval, transmit power, and modulation mode are adjusted. If the terminal's own battery is low, the sensor value is lower than the set threshold, or the sensor value changes slightly, the transmission frequency will be reduced. Further, as shown in FIG. 1, the data in B indicates how to collect data, what data to collect, how to process data, how to use data, how to transmit data, etc., and communication indicates what communication settings, radio frequency parameters, radio frequency parameters, etc. are used for transmission. Send and receive mode, etc., the network indicates what networking mode, transmission path, etc. are used in the transmission process. Different communication requirements determine different communication strategies, such as high-quality communication requirements, strategies such as data information splitting-multipath concurrency-aggregation, real-time optimization of communication settings and RF parameters, and construction of high-priority networks through core networks and base stations can be adopted, and can be dynamically allocated in actual situations.

In the present invention, according to different industry requirements, different physical environment requirements and/or different terminal conditions, the corresponding data, communication, network, etc. are dynamically provided and determined. For example, in the environmental protection industry, thousands of sites are required to report data at the same time, which requires not only low latency, but also a high amount of concurrency sent at the same time, but the time interval between two reports may be as high as 1 hour or 4 hours, which requires us to establish A multimode heterogeneous network capable of dynamically adjusting any communication parameter. Multi-mode heterogeneous network services not only provide separate access and management services for different network communications such as existing satellite links, cellular network links, RFID network management, LTE core network, WLAN network management, LoRa core network, etc.; The wireless access service of heterogeneous core networks supports converged access and unified management of multi-mode heterogeneous wireless networks. Multi-mode heterogeneous network services provide network services that dynamically adjust any communication parameters according to industry requirements or/and physical locations, such as physical communication parameters such as source coding, channel coding, modulation model, signal time slot, and transmit power can be adjusted; Flexible scheduling, flexible expansion of wireless link access and management technology, can perform equipment remote control, upgrade, parameter reading/modification, management and other functions, support link self-healing, provide high-utilization, strong stability, easy to restore professional Wireless network hosting services.

Please also refer to FIG. 9. As shown in the figure, the data is first sampled, and the sampling interval can be set according to requirements (for example, it can be sampled once in 1 minute, or once in 1 second). Then perform A/D conversion on the sampled data, and convert the analog data into digital data. The precision of the A/D conversion can also be set according to needs: it can be 8-bit, 12-bit, 16-bit, 24-bit and many more. The digital data is then transmitted through the RF (radio frequency circuit) after the source code is used for source coding, the channel code is used for channel coding, and the digital modulator is used for digital modulation. Among them, the source coding technology itself is very mature, mainly reflected in a set of standard protocols to realize its functions, these protocols include MPEG-1, MPEG-2, MPEG-4 and H.263, H.264, H.265, etc., they are mainly formulated and completed by the two major international standardization organizations ITU-T and MPEG, and the most used protocols are MPEG-4, H.264 and H.265. The types of channel coding mainly include: linear block codes, convolutional codes, concatenated codes, Turbo codes and LDPC codes. Digital modulation methods include: FSK (Frequency Shift Keying), QAM (Quadrature Amplitude Modulation), BPSK (Binary Phase Shift Keying) and so on. The above coding and modulation methods are all in the prior art, and will not be described in detail here.

In this embodiment of the present invention, the multi-mode heterogeneous network service provides a network service that dynamically adjusts any communication parameters according to industry requirements or/and physical locations, such as adjustable source coding, channel coding, modulation model, signal time slot, transmission Physical communication parameters such as power. For example, the transmit RF signal can be adjusted by PA (determines the transmit power) and fn (determines the transmit frequency). Exemplarily, the adjustment includes allocating different transmission bandwidths to different services. When the data transmission requirements of some terminals change, the multi-mode heterogeneous network adjusts the distribution of network resources to adapt to the changes in requirements. Illustratively, the adjustment includes priority adjustment of signal transmission. For example, the signals of some terminals are preferentially transmitted. For example, data of some base stations or gateways are preferentially transmitted. For example, some service signals of the terminal are preferentially transmitted. The multi-mode heterogeneous network adjusts network parameters in a timely manner based on on-site sensor and service requirements, which can ensure the implementation of important upper-layer services and improve the availability of the multi-mode heterogeneous network. Further, the adjustment includes dividing different data into different data streams and transmitting them through different communication paths. For example, part of the data is transmitted to the upper-layer service through the 4G network, part of the data is transmitted to the edge computing module through the LoRa protocol, and part of the data is transmitted through the multi-mode heterogeneous network. On the premise of meeting the service transmission requirements, reduce the network as much as possible consumption of resources.

As an example, in an urban fire protection application, multiple smoke sensor terminals are installed on each floor of a building, and the terminals have temperature identification capabilities and use one or more wireless gateways to communicate. During normal operation, all terminals are detected at a certain frequency, but data is sent to the gateway only once a few hours to report the device status (such as battery power, temperature, etc.). Low transmit power and medium receive sensitivity. When a fire occurs on a certain floor, all terminals on this floor will send smoke concentration and temperature data at a faster frequency. These data will be used by the algorithm to calculate the fire spread and the best escape route, in order to cope with the temporary increase in communication resources. If necessary, the communication between the gateway and the device enables multi-carrier frequency points, uses the 16QAM debugging method that supports higher rates, and improves the transmit power and receive sensitivity to ensure the communication distance.

Please continue to refer to FIG. 9, the transmitter calculates the optimal channel to connect with the receiver through the communication parameters, and the transmitter transmits data to the receiver through the channel. The receiving end receives through the receiving RF circuit, and sequentially outputs the signal through the digital demodulator, the channel decoder, the source encoder, and the output switch.

As another example, the air quality monitoring station used for dust monitoring on construction sites uses wireless gateways to return data, in which particulate matter sensors are used to evaluate dust conditions, and high-frequency sampling data can obtain finer dust change curves, but if the system is deployed If there are many different types of terminals, and the capacity of the gateway is limited, the frequency of sampling and backhaul can be appropriately reduced to reduce the occupation of communication resources. When there is a construction site during the day, a slightly higher sampling frequency should be used. If the wind speed is high and the dust dispersion changes rapidly, a higher sampling frequency should be used to adapt to accurate change tracking. If the construction site is not constructed at night, the sampling frequency, sampling accuracy and return frequency can be reduced. If the dust change is small, the source coding can be changed to the difference method, that is, the difference from the previous value can be represented by fewer data bits. It is also possible to accumulate multiple sampled data and compress it using a compression algorithm and send it uniformly.

In summary, the multi-mode heterogeneous network of the present invention provides network services that dynamically adjust any communication parameters according to industry requirements or/and physical locations, including adjustable source coding, channel coding, modulation model, signal time slot, transmission Power and other physical communication parameters; also supports flexible scheduling, flexible expansion of wireless link access and management technology, can perform remote control, upgrade, parameter reading/modification, management and other functions of equipment, support link self-healing, provide high utilization, Strong, stable, and easy-to-recover professional wireless network bearer services.

In some embodiments, the communication trigger source includes different requirements such as business requirements and control requirements, and the different requirements include two categories: static requirements and dynamic requirements. Static requirements are generally used to maintain the networking state of terminal devices and send basic information. Dynamic requirements are divided into various situations, such as: frequent monitoring is required to sense the accident trend of terminal equipment data, network self-healing is required for gateway/base station failures, real-time networking of mobile terminal equipment, and temporary regulation and control. The communication requirements corresponding to different communication trigger sources are also different. The communication requirements include high speed, high quality, reliability, robustness, weak network access, disconnected network access, and improved frequency utilization. Modular heterogeneous networks have many different strategies or methods to deal with different communication requirements. Multi-mode heterogeneous network strategies or methods include: split-multi-path concurrent-convergence, dynamic communication adjustment, network dynamic adjustment, base station priority allocation, multi-path simultaneous transmission-redundancy removal, multi-path rotation, communication parameter adjustment, Network relay, ad hoc network, end-to-end direct connection, end-station offload, etc.

In some embodiments, the sensing sensor of each terminal collects sensing data to obtain a communication trigger source, and after performing edge computing, communication transmission, cloud-edge coordination, etc. on multiple sensing data, not only can scheduling decisions be made for different terminals, but also Determine the communication requirements for each communication trigger source. Different communication requirements require different communication strategies, which can be appropriately deployed in practical situations. For high-quality communication requirements, strategies such as splitting-multipath concurrency-aggregation, dynamic communication adjustment, and base station priority allocation can be adopted; for communication requirements of disconnected network access, network relay, ad hoc network, and end-to-end can be adopted. end-to-end and other strategies. In this embodiment, the data splitting and aggregation of multi-path transmission is detected by adopting link aggregation of multi-standard and multi-layer networks (through link quality detection, link response time detection, link load detection, etc.) It can improve the edge throughput, so that terminals can enjoy high-speed and stable data access services no matter where they are in the network. At the same time, through the integration of communication modes of different standards, seamless access to heterogeneous networks can be realized, and an appropriate communication mode can be adaptively selected according to the network environment deployed by the terminal to improve the transmission service quality of the terminal. Convergence provides the necessary hardware support. As an embodiment, the sending end splits the sent data packet into a plurality of sub-data packets, and splices it into a complete data packet after being aggregated by the receiving end. The sender and the receiver are different terminals, and can be the sender and receiver of each other in different data transmission processes. As needed, on the basis of mixed networking, sub-data packets can be sent from the sender to the receiver through multi-path and multi-communication methods, and different strategies can be used in multi-path transmission as needed. When the terminal communicates with each other, the connection can be established through the base station or directly, instead of bridging through the base station, which reduces the bandwidth occupation of the base station. Hybrid networking adds ad-hoc network and point-to-point communication on the basis of star network. When the terminal in the blind area cannot directly connect to the base station, it can establish a mesh network with other terminals, and realize uplink communication with the help of equipment that can be connected to the base station. The terminal can switch between the star network and the mesh network; when working in the mesh network mode, the terminal can be used as a routing node or a common node.

In some embodiments, all data in the communication process will be stored in the database, and various parameters and status information for decision-making are obtained through deep learning algorithms, including communication strategy optimization parameters, path prediction parameters, resource scheduling parameters, and network failures. Reconstruction parameters, communication situational awareness information, network health status assessment information, etc. These results will be used to implement different multi-mode heterogeneous network strategies or methods, and improve the capabilities and effects of multi-mode heterogeneous network strategies or methods through continuous learning and optimization. And these results also act on the cooperation of multi-mode heterogeneous networks, which are used to control the sensor data of the terminal and the edge computing and cloud-edge co-calculation of the terminal, and even make scheduling decisions directly for the terminal. It should be understood that, precisely because of the network communication data transmission between the multi-mode heterogeneous IoT network and the data intelligent fusion platform, the continuous access and downlink of data in different formats in the data intelligent fusion platform is dynamically realized. operation, so that the data sources in the data lake of the data intelligence fusion platform can be expanded infinitely, and the data capabilities can be replicated infinitely, providing huge data resources for various business scenarios. In this embodiment, the data sources in the data lake of the data intelligent fusion platform include: data of the sensing terminal, communication big data, external data, and data generated by the algorithm middle station, and the like. In general, the data intelligent fusion platform can realize multi-industry access, including air, meteorology, soil, transportation, construction, water quality, fire insurance and other multi-industry data including environmental protection, fire protection, municipal administration, etc., first access and then integrate, Break through industry barriers; at the same time, the data intelligent fusion platform also provides multi-source heterogeneous data access, including data sources such as databases, file systems, message queues, and structured, semi-structured and unstructured data sources, and data sources can be expanded infinitely, data capabilities can be replicated indefinitely, providing huge data resources for various business scenarios; its data specifications are unified, providing a unified data dictionary and data specifications, reducing development costs and improving data quality.

It is worth noting that the core network and base station collect the communication data of base stations, routing nodes, and terminals: communication standard, communication path, signal-to-noise ratio, packet loss rate, delay, channel occupancy, etc., and make link prediction through deep learning algorithms. According to the network environment and transmission requirements (bandwidth, speed, response time, reliability, connection distance, etc.) of the terminal node, the connection method (directly connected base station, mesh network, point-to-point), transmission path (single path, multiple path), source coding (such as Huffman coding, arithmetic coding, LZ coding, etc.), modulation methods (such as FSK, GFSP, spread spectrum, BPSK, QPSK, 8PSK, 16QAM, 64QAM, etc.), channel coding (such as Turbo code), LDPC code, Polar code, LT code, etc.), signal bandwidth, transmitting frequency point, radio frequency parameters (modulation mode, rate, spectrum occupation, receiving bandwidth) and other factors are dynamically adjusted.

In some embodiments, split-multi-path concurrent-convergence is a method of data splitting and aggregating for multi-path transmission, which specifically includes splitting a sent data packet into multiple data packets, and different data packets use different communication methods. and different paths, spliced into complete data after aggregation at the receiving end. Different strategies are used according to the needs of multi-path transmission. Typically: a) data packets are split into multiple data packets, and transmitted through different paths in turn to increase robustness; b) data packets are split into multiple data packets, and the The paths are transmitted in parallel to increase network bandwidth, and c) the same communication packets are transmitted simultaneously and redundantly through different paths to increase reliability.

In some embodiments, when the blind area device cannot directly connect to the base station, a mesh network can be established with other devices, and uplink communication can be realized by means of the device that can be connected to the base station. The device can switch between the star network and the mesh network; when working in the mesh network mode, the terminal can communicate as a routing node or as a common node. FIG. 4 shows the principle of communication between terminals.

In some embodiments, when adjacent devices and devices communicate with each other, a connection may be established through a base station or directly without bridging through the base station, thereby reducing the spectrum occupation of the base station. Evaluate the communication bandwidth requirements between the two devices from the application requirements, and select the appropriate bit rate, debugging method, and control the transmit power according to the distance between the two devices and the radio frequency noise, so as to achieve the minimum occupation of spectrum resources.

In some embodiments, the terminal node dynamically adjusts parameters such as communication interval, transmit power, and debugging method according to its own power, sensor value, and sensor conversion rate. Typically, the terminal's own battery is low, the sensor value is lower than the set threshold, or the change in the sensor value is small, the frequency of transmission is reduced.

Referring to FIG. 13, the present invention provides an example of a next-generation IoT service flow.

As shown in the figure, sensor device 3 (represented by sensor 3 in the figure, similarly, sensor device 2 is represented by sensor 2, and sensor device 1 is represented by sensor 1) has the function of end computing, and can directly generate edge decisions through sensor data (In the figure, it is represented by edge computing 3) so as to directly link control 3, and the sensing data is simultaneously sent to gateway/base station 1 through ad hoc network communication. In this embodiment, the sensing data collected by the sensing device may be water, gas, electricity, soil, sound, fire, and the like. Sensor devices can be mobile terminals such as handhelds, walkie-talkies, vehicle-mounted devices, positioning terminals, and wearable terminals; the sensor data can also be voice/video/text, etc. For example, the sensing device may be a variety of video sensing terminals such as cameras, thermal imaging, and hyperspectral.

Further, sensing device 1 obtains sensing data from sensing device 2 through point-to-point communication, fuses the sensing data of the two devices, and uses edge computing 1 to automatically adjust sensing strategies if specified conditions are met (such as increasing sampling frequency, increasing sampling progress, etc.) control the sampling behavior of the sensing device 1, and request to adjust the communication parameters and strategies to obtain higher rate and highly reliable transmission through multi-mode communication, and at the same time, the linkage control 1 executes the corresponding actions. Among them, the sensing data collected by the sensing device is uploaded to the edge computing module, and the edge computing module can be a part of the terminal, or a different device connected to the terminal through short-range communication, such as a device connected to the terminal through ZigBee, Wifi, Bluetooth, etc. The edge computing module forms edge decisions based on the processing of perceptual data. Among them, the formation of edge decisions is based on data processing of one or more sensing devices. For example, the edge computing module fuses the sensing data of more than one terminal to form edge decisions. In some embodiments, the edge computing module obtains processed data based on the processing of the sensory data, for example, to implement edge correction and self-correction of the sensory data, and the processed data is further used for uploading or forming edge decisions. The edge decision of the edge computing module includes adjusting the sensing strategy of the terminal based on the processing of the sensing data, such as dynamically changing the sampling interval, sampling accuracy and transmission frequency according to the change rate of the sensing data, preset threshold, network conditions, etc., so the response can be taken into account at the same time. time, power consumption of the whole machine, and network bandwidth occupation. In addition, the edge decision-making of the edge computing module may also include executing preset behaviors based on the processing of perceptual data. The preset behaviors include, for example, triggering linkage alarms, linkage calls, linkage control valves/gates, linkage SMS/mail notifications, etc. through linkage terminals. FIG. 4 shows the trigger linkage process of edge decision.

Further, gateway/base station 1 has edge computing capabilities, which can collect data from multiple sensing terminals, have higher-level decision-making capabilities, and can be configured to directly issue commands to devices to execute drivers when the front-end and center are disconnected from the network. Control, and can adjust the communication parameters of the adjacent gateway/base station 1 to provide better communication services for high-priority devices.

All gateway/base station data finally enters the support platform through the multi-mode heterogeneous core network, and is used for calculation, display and storage through big data fusion. Real-time monitoring and analysis of on-site conditions through cloud computing and artificial intelligence algorithms. If an alarm occurs, an execution control command will be issued to the designated equipment, and the adjustment of communication parameters and strategies will be sent to the core network to dispatch communication resources to related equipment. Generate a disposal plan through the auxiliary decision-making system to provide assistance to the leader, then start the command and dispatch process, and send the integrated communication data to the gateway/base station 3. The gateway/base station 3 is associated with several mobile terminals, and the on-site personnel wear mobile terminals (mobile terminal 1 in the figure), mobile terminal 2), the ad hoc network communication between the mobile terminals is used for on-site command, and the mobile terminal 1 maintains contact with the support platform through the gateway/base station 2.

The communication layer includes a multi-mode heterogeneous intelligent IoT consisting of base stations and gateways, dynamically adjusting any communication parameters to establish a network based on industry requirements or/and physical location. Provide network support for the terminal layer, such as the integration of fixed network and mobile network, the combination of wide, medium and narrowband networks, and the integrated communication of voice/video/text/picture/data/file.

Base stations cover satellite, private network, WLAN, bridge, public network, multi-mode heterogeneous network and other communication networks, and dynamically adjust any communication parameters to establish a network according to industry requirements or/and physical location. For example, data splitting and aggregation of multi-path transmission is supported, and different strategies are adopted according to needs during multi-path transmission.

Gateways include edge AI, security, positioning, video, mid-range communication, CPE, RFID, technical detection, etc., and can realize network interconnection with different high-level protocols, including wired and wireless networks, according to industry requirements or/and physical location dynamics. Adjust any communication parameters.

The gateway or base station of the communication layer transmits data to the terminal layer through any one or more combination of methods such as Wifi, LoRa, ZigBee, Bluetooth, and carrier network. Optionally, in an area where a communication connection cannot be directly established with the gateway or base station of the communication layer, the connection between the communication layer and the terminal layer is established by means of an ad hoc network. The communication layer receives, for example, the edge decision of the edge computing module or the sensor data of the terminal through the network connection with the terminal layer.

In some embodiments, the communication layer includes a fog edge computing module, the communication layer configures a fog edge computing module in one or more gateways or base stations, and the fog edge computing module is based on the configured gateway or base station. The module's intermediate data, or edge decision, executes the preset fog edge computing content to form a fog decision with a higher level than the edge decision.

Fog decision-making includes adjusting communication parameters and strategies. If the objects of communication parameters and strategies include the communication layer, the communication layer adjusts the communication parameters and strategies accordingly to meet the needs of business data. For example, the base station or gateway preferentially transmits part of the data to the core network, such as the base station or The gateway adjusts the bandwidth allocation for different terminals or services, for example, the communication layer starts multi-mode transmission and negotiates with the terminal to propose a multi-mode connection. If the objects of communication parameters and policies include the terminal layer, the relevant terminal equipment adjusts the communication parameters and policies to optimize the data transmission at the terminal layer, for example, the terminal adjusts the frequency band, power, modulation method of signal transmission, etc., for example, the terminal negotiates with the network layer Establish a multi-mode connection, for example, the terminal preferentially transmits data with low bandwidth occupancy.

The core network of the communication layer aggregates data from multiple base stations/gateways. The next-generation Internet of Things system performs big data fusion processing on the data aggregated to the core network, and analyzes and calculates the data based on cloud computing technology, artificial intelligence algorithm technology, etc. The artificial intelligence industry algorithm center supports unified management and operation and maintenance of computing power and service resources, and can realize the fog computing, edge computing and artificial intelligence industry algorithm center itself according to industry applications, computing power, network and communication conditions. Dynamic allocation of computing power and algorithmic tasks. The containerized cluster mode is adopted, which supports flexible scheduling of computing resources, and realizes automatic expansion and contraction according to actual configuration scenarios, improving the utilization of computing resources.

In some embodiments, when the analysis and calculation result of the data satisfies the preset service rules, the upper-layer service dynamically adjusts the communication layer based on service requirements. For example, the upper-layer service control core network delivers communication policy updates to gateways and base stations. For example, the upper layer service updates the parameters and policies of the communication network, and the core network, gateway or base station performs dynamic adjustment based on the updated parameters and policies.

The upper-level business can be business applications in various scenarios such as smart city traffic management, highway traffic management, cultural relics management, fire prevention, forest fire protection, and smart grids.

Upper-layer services provide users with some interactive functions.

Optionally, the interactive function provided by the upper-layer service is a visual display service, for example, based on digital twin technology or 3D modeling technology, combined with sensor data and edge decision-making to display the on-site environment and real-time status of the terminal.

Optionally, the interaction function provided by the upper-layer service is a streaming media presentation service, for example, the streaming media data related to the service is pulled from the fusion data and played on the user's service terminal.

Optionally, the interaction function provided by the upper-layer service is a command and dispatch service, so that the remote service terminal is linked with the mobile terminal on the service site. Further, the upper-level business provides auxiliary decision-making services, and provides decision-making basis or decision-making suggestions based on technologies such as artificial intelligence and big data analysis.

In some embodiments, the service site does not have fixed gateway or base station access conditions, and network access is achieved through a mobile gateway or mobile base station to meet the command and dispatch requirements of the service site. The mobile gateway or mobile base station and the mobile terminals on the business site form an ad hoc network. On the one hand, the ad hoc network interconnects with the upper-layer business by accessing the core network, and transmits business data, such as business instruction issuance, business data upload, instant messaging On the other hand, as a part of the multi-mode heterogeneous network, the ad hoc network is managed by the communication strategy of the core network, and realizes the dynamic adjustment of the multi-mode heterogeneous network according to the actual needs of the business.

In some embodiments, the mobile terminal performs related actions at the service site, such as controlling a linkage type terminal, collecting sensor signals, and the like.

In some embodiments, the upper layer service directly sends an instruction to the terminal layer to control some terminals in the terminal layer to perform related actions, such as controlling linkage type terminals, such as controlling sensor type terminals.

In some embodiments, a terminal may access a star network or a mesh network and switch between the star network and the mesh network. When the terminal cannot directly connect to the base station, it can access the base station through the cascade connection of other terminals. When the terminal works in the mesh network mode, the terminal can be used as a routing node or a common node. It supports point-to-point communication between devices and reduces the bandwidth occupation of the base station.

In some embodiments, the multi-mode heterogeneous network dynamically adjusts any communication parameters based on industry requirements or/and physical location. Exemplarily, the adjustment includes adjusting the signal transmission of some terminals from single-mode transmission to multi-mode transmission, or from multi-mode transmission to single-mode transmission, to meet different bandwidths and data types under different scenarios and service requirements. transmission needs. For example, when the current bandwidth cannot meet the temporary high concurrent data transmission, the transmission bandwidth is increased by adjusting the single-mode transmission to the multi-mode transmission. Exemplarily, the adjustment includes allocating different transmission bandwidths to different services. When the data transmission requirements of some terminals change, the multi-mode heterogeneous network adjusts the distribution of network resources to adapt to the changes in requirements. Illustratively, the adjustment includes priority adjustment of signal transmission. For example, the signals of some terminals are preferentially transmitted. For example, data of some base stations or gateways are preferentially transmitted. For example, some service signals of the terminal are preferentially transmitted. The multi-mode heterogeneous network adjusts network parameters in a timely manner based on on-site sensor and service requirements, which can ensure the implementation of important upper-layer services and improve the availability of the multi-mode heterogeneous network.

Further, the adjustment includes dividing different data into different data streams and transmitting them through different communication paths. For example, part of the data is transmitted to the upper-layer service through the 4G network, and part of the data is transmitted to the edge computing module through the LoRa protocol. On the premise of meeting the service transmission requirements, the consumption of network resources is reduced as much as possible.

This embodiment of the present invention provides an operation process of the next-generation Internet of Things in the field of forest fire protection. It should be understood that it is only a preferred embodiment of the present invention, and is not intended to limit the patent scope of the present invention. Any equivalent structure or equivalent process transformation made by using the contents of the description and drawings of the present invention, or directly or indirectly used in Other related technical fields are similarly included in the scope of patent protection of the present invention.

The present invention can be used in forest fire prevention, security monitoring, farm management, traffic management, criminal investigation, battlefield and other scenarios. When the upper-layer service is flame detection in the forest fire protection industry, the following solutions are used to meet the service requirements: operators in forest areas have poor network coverage, and multi-mode heterogeneous base stations are deployed to cover the target area. To control costs, a single base station needs a large coverage area (corresponding to longer communication distances), and the base station cluster only provides a limited overall bandwidth. Sensor devices include flame detection terminals and cameras. Secure encryption that can be keyed by the communication endpoint characteristics or the communication information (refer to the above embodiments for encryption). The flame detection terminal has low power consumption, fast response, and a small amount of communication data, but long-distance communication is required for many points and scattered deployment; cameras have high power consumption, slow response, and large amount of communication data. The sensing device can sense the specific infrared light signal generated by the combustion of the flame. Due to the background noise in the environment, it is necessary to fuse the data of infrared sensors with multiple wavelengths, and analyze the raw signals of multiple sensors through edge computing to determine whether there is a fire. The sensing device is connected to the camera through a wired connection. After judging the presence of fire, the edge side automatically sends information to the camera. The camera completes the capture action and generates pictures/videos. Finally, as long as the fire results/pictures/videos are sent to the platform, the original signal is not required.

The flame detection terminal and the base station are connected through a low-speed and long-distance configuration. Some terminals that cannot directly connect to the base station are connected to the base station through the adjacent terminal relay. When the terminal is powered on, it tries to directly connect to the gateway/base station. By evaluating the actual connection, the communication performance between the terminal and the gateway/base station can be evaluated. When there is no fire, the communication method with the least resource occupancy is selected. If the terminal cannot directly connect to the gateway/base station, the multi-dimensional networking mode is selected. As an example, the terminal realizes communication by means of another relayed gateway/base station terminal that can be covered. Monitor the preamble signal of the relayed terminal. If there is no detected signal, it will enter the sleep mode immediately. If the signal is identified, it will start to receive the entire data packet and resend the data packet to the gateway/base station.

The flame detection terminal samples at a regular speed, and analyzes whether there is a fire through the terminal calculation. If there is no fire, it dynamically sends the pre-judgment result, status information and other communication parameters to the server according to the detection pre-judgment result, and the interval increases and shortens as needed. As the risk of a fire sensed increases, the frequency of detection increases, as does the sending of relevant information.

The cloud computing engine requests some raw data fragments from the device at different time periods. These raw data fragments will be used for background noise analysis. Combined with historical big data and current meteorological big data, an artificial intelligence algorithm is used to obtain a suitable detection parameter set. And send it to the base station, and the base station sends it to the terminal one by one in a time-sharing manner. The terminal uses the new detection parameter set for flame detection.

The PTZ camera scans the surrounding area according to the designated cruise trajectory, and sends video data to the server in a certain period. The video data is displayed on the large screen of the monitoring center through the streaming media service and visualization engine. Multiple PTZs share the base station bandwidth in time-sharing.

When a flame detection terminal detects a flame signal, it immediately sends an alarm signal to the background, and immediately sends the data to the gateway/base station through the established communication network, and the gateway/base station sends the data to the artificial intelligence through the multi-mode heterogeneous core network. The business platform and the background platform start the emergency process according to the business needs of the industry. The artificial intelligence business platform issues control commands through the multi-mode heterogeneous core network to control the rotation of the camera near the flame detection terminal, and controls it to shoot video in the direction of the flame detection terminal. Through the multi-mode heterogeneous core network, commands are sent to the on-site base station through the gateway/base station, and the base station dynamically adjusts the communication resources to the flame detection terminal and camera. Other devices far away from the fire area temporarily reduce the communication priority and give up communication resources. The terminal that finds the fire starts the rapid detection process, detects the flame intensity, and immediately sends it to the server through the gateway/base station. At the same time, the camera also sends real-time continuous video to the server to show the spread of the fire, so as to provide data support for firefighters to make decisions.

When the upper-level business is the emergency command and dispatch of forest fire prevention, the following solutions are used to meet business needs:

In the absence of fire, there is no need for command and dispatch on site, and there is no need to configure a base station separately. When a fire is found, mobile multi-mode heterogeneous base stations are deployed on site, and rescuers are equipped with mobile command and dispatch terminals. Mobile terminals support multimedia communication: information, voice, image, positioning, etc. When the on-site communication resources are sufficient, video and voice can be turned on at the same time. When the on-site communication resources are tight or the distance between the terminal and the base station is too far to support high-speed communication, the converged communication service of the support layer will control the corresponding device to switch to the single-voice mode. Heterogeneous core network negotiation, dynamically adjust the communication and network to ensure the communication distance of the device, if the communication rate is still limited, turn on the short message communication mode.

Further, the multi-mode heterogeneous network management platform will, according to the forest fire spread area and spread time predicted by the artificial intelligence management platform, according to the distance from the command and dispatch terminal to the fire field, combined with whether the command and dispatch terminal will be in the area where the fire is about to spread in the short term. In case of emergencies, the bandwidth and rate are dynamically adjusted to give priority to ensuring the communication quality of command and dispatch terminals that may be in a dangerous state. The artificial intelligence management platform obtains geographic data, vegetation data, forest fire factor data, meteorological data, real-time data of sensor terminals, fire-extinguishing resources and other data from the data lake of the data intelligent fusion platform, and calculates the fire center and current fire area through deep learning algorithms, fire spread trend, feasible rescue paths, etc., and combined with the location data of the command and dispatch terminal, the optimal rescue path for on-site rescuers is deduced. Through the trajectory prediction of the command and dispatch terminal, the artificial intelligence management platform can determine the dynamic networking requirements of the command and dispatch terminal: which terminals are key terminals, the required communication rate, etc., and send the requirements to the multi-mode heterogeneous core network. The heterogeneous core network retrieves historical communication big data from the data lake, combines the on-site communication environment data, and deduces the optimal networking method and communication resource scheduling strategy through deep learning algorithms, and issues the final control commands through the gateway/base station To the command and dispatch terminal and/or the on-site mobile gateway/base station, the command and dispatch terminal forms a network according to the command and transmits various streaming media information in real time for further use by the platform.

During the dispatching process, the integrated communication middle station provides three major service functions: (1) Instant messaging function, which is used to issue command and dispatch instructions and listen to on-site situation reports. The integrated communication middle station can establish communication between artificial intelligence business platform and field terminal, terminal and terminal, platform and multi-terminal grouping. Depending on the network connection, different communication methods can be established, typically video calls, audio calls, and text communications. Use video calls for good communication conditions, audio calls for normal communication conditions, and text communication for poor communication conditions. When it is really necessary to use a high-speed communication mode but the current terminal network connection rate is not supported, the artificial intelligence service platform can initiate a networking evaluation to the multi-mode heterogeneous core network, and the core network will evaluate and regroup through the deep learning algorithm according to the current networking status and environment. Whether the communication rate allocation of the specified terminal can be satisfied by means of network, temporary allocation, etc., and the allocation is performed if the conditions are met. When using text communication, support using the language processing unit in the algorithm center to convert the platform's voice into text and send it to the terminal; when using group calls, support video calls for some terminals and voice calls for some terminals. The artificial intelligence industry algorithm predicts and simulates the spread of fire based on current and historical data, and can directly output automatic dispatching instructions. These dispatching instructions can be directly sent to the terminal through the integrated communication center without manual participation. According to the networking situation of the terminal, Automatic scheduling instructions can be issued in voice or text format. The original format of scheduling instructions can be voice or text (of course, it can also include video, pictures or other types of files). Through the algorithm platform TTS speech synthesis algorithm and NPL natural language recognition algorithm, the scheduling instructions can be converted between voice and text. (2) Location positioning, which provides the collection and circulation of terminal location information. The algorithm middle station uses location information to generate scheduling decisions for on-site personnel, the digital twin middle station uses location information for visual display, and the multi-mode heterogeneous core network uses location information for dynamic networking and communication resource allocation. (3) On-site monitoring, the artificial intelligence business platform can actively perform operations such as pulling the terminal video stream, controlling the terminal to take pictures, and controlling the terminal recording. These operations do not require any operation from the terminal, reducing unnecessary intervention by rescuers.

According to the fire control situation, rescue personnel situation, real-time dispatch of artificial intelligence business platform and other information, the platform side calculates the communication requirements in real time and dynamically adjusts the communication strategy to ensure the real-time, dynamic and coherent communication connection of the command and dispatch terminal and the on-site sensor equipment. The digital twin middle station can show to the command center: artificial intelligence industry algorithm middle station prediction simulation data (such as fire spread prediction), location data of on-site rescuers, communication network data (base station/gateway coverage area, communication equipment interconnection, etc.) to help the command and dispatch of the command center.

Although the present invention has been described in considerable detail with reference to certain embodiments thereof, the invention may be variously embodied without departing from the spirit or scope of the invention. Therefore, the following claims should not be limited to the description of the embodiments contained herein in any way.

1. An Internet of Thing (IOT) node comprising:
memory, firmware, and communication interface for communicating with other nodes;
wherein said communication with the other nodes is adjusted with one or more of the following: communication interval, transmit power, and modulation mode in connection with modification of carrier frequency, source coding, and/or channel coding; and wherein sampling interval and sampling accuracy for the sensor data are adjusted in connection one or more of: change of the sensor data, preset threshold, network condition, relationship among sensor data from other nodes
